(19) United States
(12) Patent Application Publication
(10) Pub. No.: US 2016/0285982 A1
(43) Pub. Date: Sep. 29, 2016

(54) Social Network for Travelers

(71) Applicant: INTERCEPT, LLC, CLIFTON, VA (US)

(72) Inventors: Charles Clinton Abercrombie, III, Clifton, VA (US); Allen D. Cassano, Broomnfield, CO (US)

(73) Assignee: INTERCEPT, LLC, CLIFTON, VA (US)

(21) Appl. No.: 15/174,072

(22) Filed: Jun. 6, 2016

Related U.S. Application Data
(63) Continuation-in-part of application No. 14/513,865, filed on Oct. 14, 2014.
Application No. 14/513,865 is a continuation-in-part of application No. 14/261,454, filed on Apr. 25, 2014, now Pat. No. 9,325,755.
Application No. 14/261,454 is a continuation of application No. 13/684,649, filed on Nov. 26, 2012, now Pat. No. 8,751,509.
Application No. 13/684,649 is a continuation of application No. 11/857,977, filed on Sep. 19, 2007, now Pat. No. 8,341,162.

(51) Int. Cl. H04L 29/08; G06F 3/0481; G06F 3/0486; G06Q 50/00; G06F 17/30

(52) U.S. Cl. CPC H04L 67/22; H04L 67/306; G06Q 50/01; G06F 17/30867; H04L 67/18; G06F 3/0486; G06F 3/04817

(57) ABSTRACT

A method of correlating events between multiple people is disclosed including generating a statistically unique event code. The statistically unique event code uniquely identifies the event and is associated with the event. The statistically unique event code is unique for at least a period of time up until the event happens. The statistically unique event code is provided when a person joins the event (e.g. printed on a ticket, transmitted in a data record, etc.). In a social network in which the person is a member, the statistically unique event code is associated with the person. A buddy list of the person is searched for other members of the social network for an overlap in which the person and one of the buddies of the person will be co-located (e.g., matching statistically unique event codes or at a location near the event, etc.).

### CROSS-REFERENCE TO RELATED APPLICATION

This application is a continuation-in-part of U.S. patent application Ser. No. 14/513,865 filed Oct. 14, 2014, which in turn is a continuation-in-part of U.S. Pat. No. 9,325,755 issued Apr. 26, 2016, which in turn is a continuation-in-part of U.S. Pat. No. 8,751,509 issued Jun. 10, 2014, which in turn is a continuation of U.S. Pat. No. 8,341,162 issued Dec. 25, 2012, the disclosure of such are hereby incorporated by reference.

### FIELD

This invention relates to the field of data processing and more particularly to a system for privately managing and notifying travelers of travel plans of friends and family.

### BACKGROUND

Social networks are well known. Early in the history of the Internet, social networks primarily provided a dating service whereby a user would register and create a profile containing a posting. In this, they would describe themselves, their likes, dislikes, hobbies, work, etc. Once created, the posting is advertised to others looking for a partner.

Later, such networks evolved to concentrate on needs other than dating. Web sites the likes of Myspace.com and Facebook.com appeal to the social needs of people, providing a canvas on which members write about themselves, post pictures, and the like.

For the more business focused, web sites such as Linkedin.com emerged to provide online business networking. Such a network provides secure access and a system that mimics business relationship networking. For example, once you are invited to become linked to an associate (or buddy) member and accept, you have the ability to keep in contact with that associate, plus, if other associates of your direct associate allow, you will be able to network with them as well.

Several patents and patent publications describe social networks or specialized features of certain social networks. U.S. Pat. No. 7,188,153 to Lunt, et al., describes a social network that includes a feature to upload files such as images (pictures) that can be viewed by your contacts.

U.S. Pat. No. 7,069,308 to Abrams describes a method of more effectively connecting people in a social network.

U.S. Pat. No. 7,117,254 to Lunt, et al., describes a social network that includes an invitation feature for members to invite new members to join their private network and for members to write positive comments about other members.

U.S. Pat. Application No. 2006/0042483 to Work, et al., describes a method for evaluating reputations of users in a social network.

U.S. Pat. Application No. 2006/0041543 to Achlioptas describes a method for navigating and searching in a social network.

Past methods of notifying others when traveling included posting vacation schedules on calendars such as shared or networked calendars that are viewable by many people within a team, group, organization, etc. Other methods of notifying others when traveling included posting messages describing travels on popular social networks. In general, it is unwise to publically announce travels as such information in the wrong hands has the potential to invite robbery or other crimes. Basically, when a person is traveling, they may want to share certain parts of their plans with others, but not their full itinerary. For example, if a person plans to be in Rome for six months, it might be nice to meet with a buddy who will be in Rome for one of those days, but that person might not want to disclose to their buddy that they are in Rome for six months.

Unfortunately, posting vacation/travel schedules on shared calendars or on social networks generally discloses your entire schedule to friends, family, co-workers, and, unfortunately, to potential thieves.

At times, when a person is traveling or attending an event, it is desired to find out if any of that person's circle of contacts, associates, buddies, family, etc., will be traveling. For example, if a person is attending a baseball game, they may want to know if anyone else from their circle will also be attending the same game, making it possible to share a ride, get together before or after the game, change seats to sit closer, etc. Presently, to inform one's circle of an upcoming attendance at an event, the person need make a conscious effort to notify others by, for example, sending an email with a description to a set of friends/colleagues, post a description of the event on a social network, etc. This requires that those friends/colleagues look at their email or view the social network.

To better provide notification, it is desirable to notify a selected set of individuals within a person's circle of family and friends shortly after the person commits to attending the event, the event being any type of event including, but not limited to, attending a concert, attending a tradeshow, attending a rally, attending a sporting event, buying an airline, train, ship, or bus ticket, reserving a rental car, reserving a hotel room, etc.

What is needed is a system that will provide the usual social networking tools with the addition of providing tools for finding out when a user is on a layover, trip, or vacation in the same location as another user.

### SUMMARY

In one embodiment, a computer system having event codes is disclosed including a first and second computer. A first software system executing on the first computer sends a transaction to a second software system executing on the second computer. The transaction includes a request for a statistically unique event code and information that identifies an event. The second software system executing on the second computer receives the transaction and generates the statistically unique event code that uniquely relates to the event and the second software system transmits the statistically unique event code to the first software system. The first software system provides the statistically unique event code (e.g. to a user of the first software system on, for example, a ticket or receipt or to a third software system in a transaction that comprises identification of the user and the statistically unique event code).

In another embodiment, a method of correlating events between multiple people is disclosed including (a) generating a statistically unique event code. This event code is either generated by a computer system or it is manually created. The statistically unique event code uniquely identifies an event, the statistically unique event code associated with the event, and the statistically unique event code being unique for at least a period of time up until the event happens. The (b) statistically unique event code is provided when a person joins the event (e.g. printed on a ticket, transmitted in a data record, etc.). (c) In a social network in which the person is a member, the statistically unique event code is associated with the person. (d) A buddy list of the person is then searched for other members of the social network for an overlap in which the person and one of the buddies of the person will be co-located (e.g., matching statistically unique event codes or at a location near the event, etc.).

In another embodiment, a signal tangibly embodied in a non-transitory storage medium for correlating events is disclosed. The at least one instruction includes (a) computer readable instructions that generate a statistically unique event code that is uniquely related to an event and (b) computer readable instructions that associate the statistically unique event code with a person when the person joins the event. (c) Computer readable instructions create records that include identification of the person and the statistically unique event code and (d) computer readable instructions search the records for a set of overlapping layovers in which a layover of the person and a layover of a buddy of the person have the same location. (e) For each overlapping layover in the set of overlapping layovers, computer readable instructions notify the person and/or the buddy of the person regarding of the overlapping layover.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates an exemplary schematic view of a system for travelers with layovers.

FIG. 1A illustrates a second exemplary schematic view of the system for travelers with layovers.

FIG. 2 illustrates a third exemplary schematic view of the system for travelers with layovers.

FIG. 3 illustrates a fourth exemplary schematic view of the system of system for travelers with layovers.

FIG. 3A illustrates a fifth exemplary schematic view of the system for travelers with layovers.

FIG. 4 illustrates a sixth exemplary schematic view of the system for travelers with layovers.

FIG. 5 illustrates a first exemplary flow chart of the system for travelers with layovers.

FIG. 5A illustrates a second exemplary flow chart of the system for travelers with layovers.

FIG. 6 illustrates a third exemplary flow chart of the system for travelers with layovers.

FIG. 6A illustrates a fourth exemplary flow chart of the system for travelers with layovers.

FIG. 6B illustrates a fifth exemplary flow chart of the system for travelers with layovers.

FIG. 7 illustrates a sixth exemplary flow chart of the system for travelers with layovers.

FIG. 8 illustrates an exemplary member data record of the system for travelers with layovers.

FIG. 9 illustrates an exemplary relationship example of several member data record of the system for travelers with layovers.

FIG. 10 illustrates a directed graph depicting the relationship between the several member data record in the example of FIG. 9 of the system for travelers with layovers.

FIG. 10A illustrates a seventh exemplary flow chart for preventing duplicate notifications of the system for travelers with layovers.

FIG. 11 illustrates a eighth exemplary flow chart for adding a member to a buddy list of the system for travelers with layovers.

FIG. 12 illustrates a table showing an exemplary schedule of the system for travelers with layovers.

FIG. 13 illustrates an exemplary table showing layovers of the exemplary schedule from FIG. 12 of the system for travelers with layovers.

FIG. 14 illustrates an exemplary table showing an exemplary location thesaurus of the system for travelers with layovers.

FIG. 15 illustrates a schematic diagram of a typical computer system used by the system for travelers with layovers.

FIG. 16 illustrates a typical user interface for creating a member account of the system for travelers with layovers.

FIG. 17 illustrates a typical user interface for inviting a member to be a buddy (friend) of the system for travelers with layovers.

FIG. 18 illustrates a relationship table between an exemplary set of events and event codes.

FIG. 19 illustrates a relationship table between an exemplary set of events and event codes.

FIG. 20 illustrates a first exemplary transaction sequence for obtaining and enumerating for event codes.

FIG. 21 illustrates a second exemplary transaction sequence for obtaining and enumerating for event codes.

FIG. 22 illustrates an exemplary user interface for manual entry of event codes.

FIG. 23 illustrates an exemplary flow chart of the system for travelers with layovers in which an event code is translated into a date range (overlap).

FIG. 24 illustrates a first view of an exemplary data input user interface.

FIG. 25 illustrates a second view or an exemplary data input user interface.

FIG. 26 illustrates a third view of an exemplary data input user interface.

### DETAILED DESCRIPTION

Reference will now be made in detail to the invention, examples of which are illustrated in the accompanying drawings. Throughout the following detailed description, the same reference numerals refer to the same elements in all figures.

Throughout this specification, the term, statistically unique value, represents a value that is unique at the time the value is issued and will likely remain unique throughout the expected useful life of the value. For example, if a statistically unique value of 1357B is used to identify an event that occurs on Aug. 21, 2014, during the time up until Aug. 21, 2014 and for any reasonable time after, that value, 1357B, is unique, not being assigned to any other event. Although, it is anticipated that once a particular value is assigned to an event, it is never reused (given almost infinite value choices), by being statistically unique, the value of 1357B is available for reuse at some time after the event occurs, perhaps being assigned to the same event occurring on Aug. 21, 2015, etc. The significance of being statistically unique is that the value represents one specific event and only one event during the time in which the event is of any significance to any person.

The term location for the purpose of the system for travelers with layovers relates to a place that is convenient for two or more members of the social network to meet during a layover, visit, trip, etc. Since the two or more members are typically friends or co-workers, these members are likely aware of each other's primary location such as where they live, so when a friend or co-worker is in visiting your town/location, they will likely know that you live there and attempt to contact you (or not) as time permits. On the other hand, if you are traveling to another location and that friend or co-worker is also traveling to that same location at the same or an overlapping time period, it was not always so easy to know that you would both be in the same location. For example, if one member has a layover in Oakland and another in San Francisco, the location is the greater bay area since such would allow for both members to easily meet, perhaps using BART to travel to an agreed upon location in San Francisco. The term layover is used to describe a city/location in which the member is located for an amount of time, typically a location that is not the home of the member. Pilots, flight attendants and truck drivers often have layovers in the course of their employment. For example, a pilot scheduled to fly from Tampa arriving in San Francisco at 5:00 PM and leaving the next morning has an overnight layover.

The system for travelers with layovers is not limited in any way to pilots, flight attendants and truck drivers. Any user of the social network is capable of having a layover in a certain geographic region. For example, two members of the social network work for different companies. In the course of their work, both of these members need to be in Taipei. The time they are in Taipei is considered a layover for the purpose of the disclosed system. Therefore, if the two member's layovers in Taipei overlap, the system for travelers with layovers will inform one or both members of such overlap and, with this notification, the members can arrange to meet socially. In this example, it is also anticipated that the notification be made to the member(s) through the social network when the member(s) access the social network.

Throughout this description, when two members have a corresponding overlap or layover, a notification is sent to one or both of the members. There are many ways known in the industry to send such a notification including, but not limited to, mail (post), email, text message, and page. The recipient has also many different ways to receive such notification on a plethora of devices including, but not limited to, mail boxes, personal computers, personal digital assistants (PDAs), cell phones, smart phones, pagers and PDA-cell phones (e.g., Blackberry®), tablet computers, etc.

Throughout this description, the term “member” refers to a registered user of the social network system of the system for travelers with layovers. The term “buddy” is another member of this social network system and is a person who is known to the member and has been indicated by the member to the social network as such. The term “layover” refers to a place where the member and/or buddy are located for a period of time (e.g., one or both have a layover in San Francisco for the first three days in May). It should be noted that if the member or buddy are at home, in some situations, this is a layover, though for the most part, it is anticipated that both members know where each other live. Throughout this description, the term “overlapping layover” refers to two or more members having a layover in the same location with a certain overlap in stays. For example, overlapping layovers exist when the member is visiting San Francisco for a first period of time and their buddy is also in San Francisco for a second period of time in which a minimum amount of time is common between the first period of time and the second period of time (e.g. at least one second, one minute, one hour, eight hours, one day, etc.).

The system for travelers with layovers has many benefits. For example, the system for travelers with layovers provides information to travelers to optimize their free time when on layovers, improving employee morale. Airlines use of the system for travelers with layovers provides improved employee morale and, in some circumstances, is used to determine when compatible flight crews/flight attendants are on common layovers.

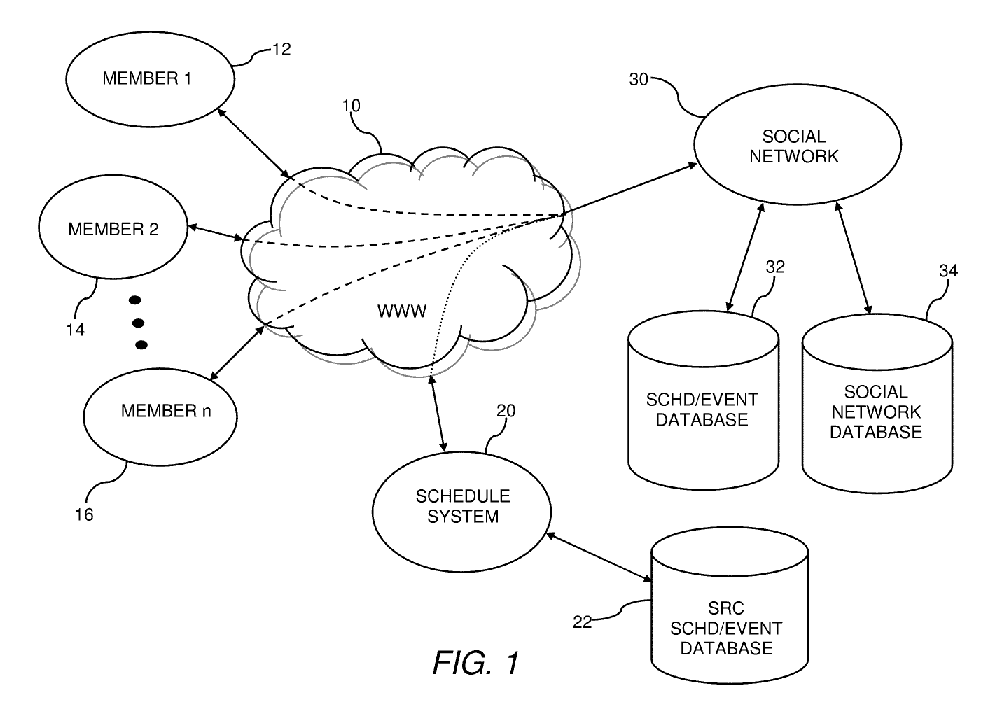

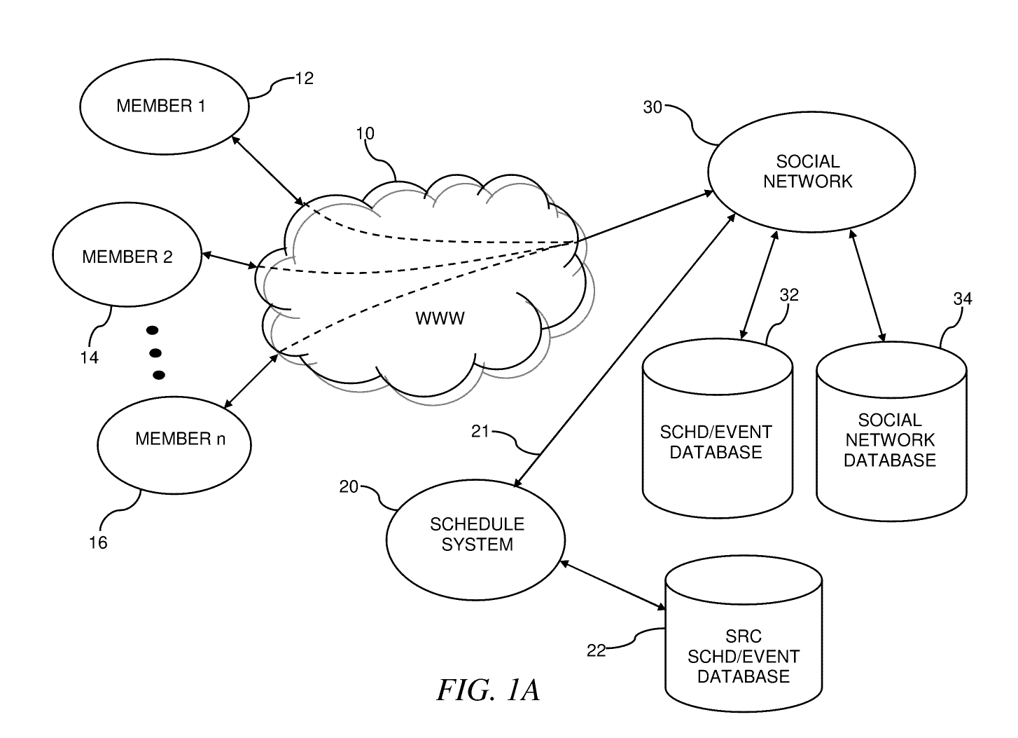

Referring to FIG. 1, a schematic view of a system for travelers with layovers is shown. In this embodiment, a schedule system 20 is external to the social network 30. A schedule system 20 is, for example, an airline personnel schedule system that assigns pilots and flight attendants to specific flight schedules. Another example of a schedule system 20 is a trucking company schedule system that assigns truckers to specific routes. Another example of a schedule system 20 is a reservation system such as an airline reservation system or general reservation system. Another example of a schedule system 20 is an itinerary organizing system such as a system that manages certain events like trade shows, conferences, sporting events, etc. In the itinerary organizing system, it is anticipated that, in some embodiments, the itinerary organizing system provides a unique event code for each event being organized. The schedule system 20 is any system that includes a scheduling capability whereby that system creates the schedule entry either through manual input, a specific event date, data from the end user (e.g., a member), etc. In some embodiments, the schedule system 20 has a set of pre-determined events, trips, concerts, meetings, etc., and the user of the schedule system 20 selects, purchases, or joins one such event. For example in which the schedule system 20 is a ticketing system for events, a user of the schedule system 20 selects an event, for example purchases tickets to a football game, and the scheduling system 20 creates a schedule/event indicating that the user will be in the location of that event on the date and time of the event. In another example, an airline has specific flights, typically having a flight number. For example, airline X has a flight number D240A the leaves Atlanta at 4:00 PM and arrives in Rome at 8:00 AM. In such, when a user purchases a ticket in their name for flight number D240A, such is considered an event and the scheduling system 20 creates an event, knowing the date that the user departs from Atlanta.

In some embodiments, each event is given a unique code. In the above example of a football game, the unique code is, for example, a sequence of characters (e.g. numbers and letters) that uniquely identifies that particular football game. One exemplary implementation would be to use a 14 digit code, in which the first four characters indicate the type of code (e.g. “FTBL” for football), the next two characters represent the location (e.g. “TB” for Tampa Bay), and the next eight characters indicate the date of the event (e.g. “12052014” for Dec. 5, 2014). Likewise, in the above example of a flight, the unique code is, for example, a sequence of characters (e.g. numbers and letters) that uniquely identifies that particular flight. One exemplary implementation would be to use a 16 digit code, in which the first four characters indicate the airline (e.g. “DL00” for Delta), the next four characters represent the flight number (e.g. “0240” for flight number D240A), and the next eight characters indicate the date of the event (e.g. “12052014” for Dec. 5, 2014).

By including such event codes 474 (see FIG. 18) with or without the user's schedule information, the system for travelers with layovers provides additional abilities for the members to distinguish between other members that will be in the same locale, or be traveling between the same two cities as different from other members who will be at the same event or on the same flight. For example, two members are traveling to Tampa, one visiting family and one going to a football game. One does not have a unique code and the other has the unique code of “FTBLTB12052014.” Since these codes do not match, the member going to the football game knows that the other member will not be at that game. In a similar example, two members traveling from Atlanta to Rome on the same date, one has the unique code of “DL00024012052014” and the other has the unique code of “AIT0007712052014.” Since these codes do not match, the two members are known to be on different airlines.

In the above examples, if a member only wants to be notified if they share the same event, the member, through administrative tools, informs the system of such and will only receive notification if the overlap includes an event, such as both are flying on the same flight or both are attending the same football game. In such, the members have a tool to find other members (buddies/friends) who will be at the same event so that the members are able to share a ride (saving energy and costs), meet before/after the event, and change seats to sit near each other. Likewise, if a member only wants to be notified if they have an overlap but do not share the same event, the member, through administrative tools, informs the system of such and will only receive notification if they have an overlapping itinerary but do not share the event, such as both are in Tampa, but the buddy is not attending the same football game. In such, the members have a tool to find other members (buddies/friends) who will be in the same location but not at the event, and the member then has time to ask that/those buddy/buddies to join in the event (e.g. if it is a fund raiser, etc.).

In some embodiments, the user (member and/or buddy) does not directly enter schedule data into the schedule system 20, rather the user is scheduled by the schedule system and/or choose certain already available options on the schedule system which will determine when the user (member or buddy) will travel (e.g., the user selects a flight that has a pre-determined schedule). The schedule system 20 has access to a source schedule/event database 22 where the scheduling and/or event data is stored. In this embodiment, part or all of the schedule/event data from the source schedule/event database 22 is uploaded to the social network 30 through a network such as the Internet (WWW) 10. The social network 30 extracts the data needed to perform layover matching and stores at least that data in a schedule/event database 32. In some embodiment, the uploaded schedule/event data is processed as it is received and not stored in the schedule/event database 32. As with many social network systems, the social network 30 has its own social network database 34 for storing security information, member information, etc. In this embodiment, several members 12/14/16 are shown connected to the social network 30 through the network 10. As an example, the members 12/14/16 are pilots, flight attendants or truckers.

Referring to FIG. 1A, another schematic view of the system for travelers with layovers is shown. In this embodiment, as with that of FIG. 1, a schedule system 20 is external to the social network 30. A schedule system 20 is, for example, an airline personnel schedule system that assigns pilots and flight attendants to specific flight schedules. Another example of a schedule system 20 is a trucking company schedule system that assigns truckers to specific routes. In alternate embodiments, the schedule system 20 is any system that includes a scheduling capability as described above. The schedule system 20 has access to a source schedule/event database 22 where the scheduling and/or event data is stored. In this embodiment, part or all of the schedule/event data from the source schedule/event database 22 is uploaded to the social network 30 through a direct link 21 such as a digital transmission line (e.g., T1, T3), magnetic tape, disk, etc. This embodiment adds additional security to the sensitive schedule/event data that is being transferred. The social network 30 extracts the data needed to perform layover matching and stores at least that data in a schedule/event database 32. In some embodiment, the uploaded schedule/event data is processed as it is received and not stored in the schedule database 32. As with many social network systems, the social network 30 has its own social network database 34 for storing security information, member information, etc. In this embodiment, several members 12/14/16 are connected to the social network 30 through the network 10. As an example, the members are pilots, flight attendants or truckers. In practice, members are registered; in that, each member 12/14/16 provides personal information to the social network 30 such as name, phone number and a username/password. The user name is used to authenticate the member 12/14/16 each time the member 12/14/16 accesses the social network 30. Any number of members 12/14/16 are possible.

It is anticipated that, for some members 12/14/16, the member's name lacks sufficient uniqueness as to properly identify that member 12/14/16 across multiple systems (e.g., there are multiple flight attendants with the same first and last names). To overcome ambiguity, it is anticipated that the social network 30 provides one or more user registrations, in which, each member 12/14/16 provides further identification for each schedule system 20 of which they are a part. For example, Tina Jones is a member of the social network 30 and is known as Tina34. Tina is a pilot for United Airlines and her identification number is 123456. Tina Jones also uses Expedia and her identification for Expedia is her email address, tina@yahoo.com. The social network 30 provides tool for each member 12/14/16 to create associations between the member's account on the social network 30 and schedule systems 20, and these associations are stored, for example, in the social network database 34. These associations identify the schedule system 20 (e.g. United Airlines) and the member 12/14/16 within that schedule system 20 (e.g. badge number 123456) so that, as the schedule data is processed by the social network system 30, finding schedule records for a person with badge number 123456 will correlate to social network member Tina34, etc.

Likewise, it is anticipated that as periodic schedule downloads occur, some or all of the schedule data is repetitive. For example, if Tina Jones is scheduled to fly from Detroit to Amsterdam at 3:30 PM on August 21, arriving at 7:00 AM on August 22, then each day before August 21, this information is present in the data that is transferred from the schedule system 20 to the social network system 30. If Tina Jones is a buddy to Mike Smith, and Mike Smith will also have a layover in Amsterdam on August 22, then the first time that this schedule data is downloaded from the schedule system 20 to the social network 30, Tina and/or Mike are notified of the overlap. Alternatively, in some embodiments, Tina and/or Mike are notified at one or more a predetermined intervals before the overlap. For example, Tina and/or Mike are notified 10 days before the overlap. In another example, Tina and/or Mike are notified at 10 days before the overlap and at 2 days before the overlap. In some embodiments, the notification predetermined interval(s) is/are fixed (system-wide) while in some embodiments, the notification predetermined interval(s) is/are on a per-member basis and mechanisms are provided for each member to change/set their individual notification predetermined interval(s). Alternately, it is anticipated that the schedule system 20 only download changes to the social network 30 (e.g., additions of schedule entries, changes to an existing schedule entry, cancellation of a scheduled entry, etc.)

Since it is anticipated that in some embodiments, this same schedule datum is downloaded multiple times, it is desired to suppress future notifications so that Tina and/or Mike, for example, do not receive notification every time the schedule data is transferred. To this, mechanisms are optionally provided to retain knowledge of prior notifications or prior downloads. In such, if the same notification as a prior notification is detected or if the same download record as a prior download record is detected, notification is suppressed.

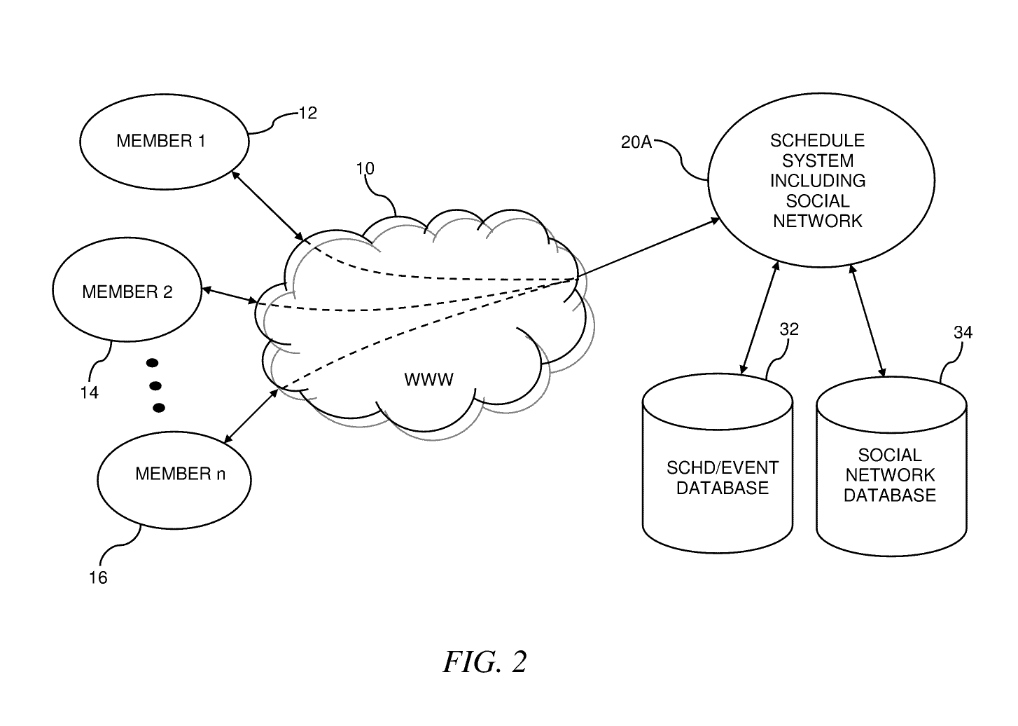

Likewise, should the scheduled layover change or get canceled, the social network 30 recognizes the change, for example, by comparing a change record to a previously received record, and the social network 30 determines if the changed or canceled layover was part of an overlapping layover and if it was a part of an overlapping layover, the social network 30 notifies one or more members 12/14/16 (see FIG. 2) of the change.

As with FIG. 1, this arrangement also optionally supports event codes 474 as described above.

Referring to FIG. 2, another schematic view of the system for travelers with layovers is shown. In this embodiment, the schedule system 20A is part and the same as the social network. In such, the schedule system 20A provides the features of a social network, at least those that provide notification of member layover overlap. For simplicity, the following examples will use an airline personnel schedule system that assigns pilots and flight attendants to specific flight schedules, although it is anticipated that any system with scheduling capability is a possible user of the present invention. The schedule system 20A has access to a schedule database 32 where the scheduling data is stored. The social network 20A extracts the data needed to perform layover matching and notifies the members 12/14/16 as will be described. As with many social network systems, the social network 20A has its own social network database 34 for storing security information, member information, etc. In this embodiment, several members 12/14/16 are connected to the social network 20A through the network 10. As an example, the members are pilots, flight attendants or truckers.

As with FIG. 1, this arrangement also optionally supports event codes 474 as described above.

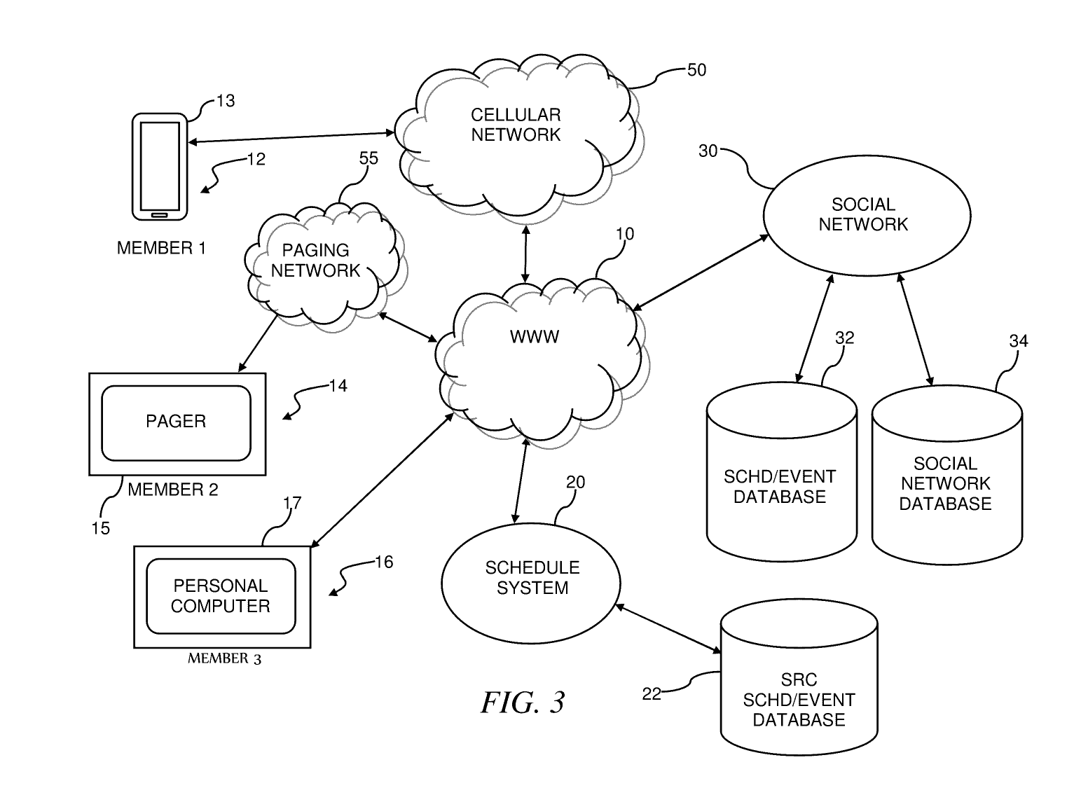

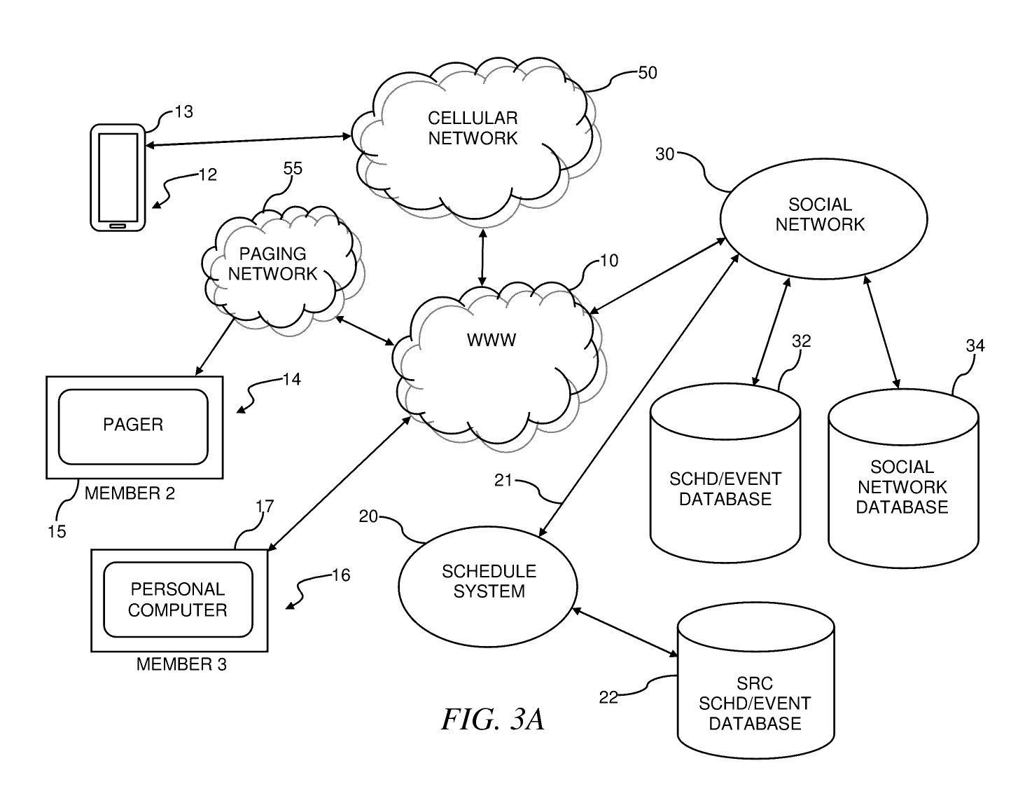

Referring to FIG. 3, another schematic view of the system for travelers with layovers is shown. In this, a schedule system 20 is external to the social network 30. A schedule system 20 is, for example, an airline personnel schedule system that assigns pilots and flight attendants to specific flight schedules. The schedule system 20 has access to a source schedule/event database 22 where the scheduling data is stored. In this embodiment, part or all of the schedule data from the source schedule/event database 22 is uploaded to the social network 30 through a network such as the Internet (WWW) 10. The social network 30 extracts the data needed to perform layover matching and stores at least that data in a schedule database 32. In some embodiment, the uploaded schedule data is processed as it is received and layover information is stored in the schedule database 32. As overlapping layovers are detected for members and their buddies, the member and buddy are notified of the overlapping layover. As with many social network systems, the social network 30 has its own social network database 34 for storing security information, member information, etc. In this embodiment, several members 12/14/16 are directly or indirectly connected to the social network 30 through the network 10. The first user has a smartphone 13 connected through the cellular network 50 and notified either by a voice message or text message sent from the social network 30, through the Internet 10 and through the cellular network 50 to the smartphone 13 used by the first member 12. The second member 14 is connected through the paging network 55 and notified by a alpha or numeric page message sent from the social network 30, through the Internet 10 and through the paging network 55 to a pager 15 used by the second member 14. The third user 16 is connected through the Internet 10 and notified by an email message sent from the social network 30 through the Internet 10 to a personal computer 17 used by the third member 16.

In some embodiments, should the scheduled layover change or get canceled, the social network 30 recognizes the change, for example, by comparing a changed record to a previously received record, and the social network 30 determines if the changed or canceled layover was part of an overlapping layover and if it was a part of an overlapping layover, the social network 30 notifies one or more members 12/14/16 of the change (either one, several or all members 12/14/16 that are involved in the previous overlapping layover). For example, when the record is downloaded from the schedule system 20, the record includes an action such as “new,” “changed,” or “canceled.”

As with FIG. 1, this arrangement also optionally supports event codes 474 as described above.

Referring to FIG. 3A, another schematic view of the system for travelers with layovers is shown. In this, a schedule system 20 is external to the social network 30. A schedule system 20 is, for example, an airline personnel schedule system that assigns pilots and flight attendants to specific flight schedules. The schedule system 20 has access to a source schedule/event database 22 where the scheduling data is stored. In this embodiment, part or all of the schedule data from the source schedule/event database 22 is uploaded to the social network 30 through a private connection 21, for example, a private line such as T1-carrier, T3-carrier, etc. The social network 30 extracts the data needed to perform layover matching and stores at least that data in a schedule database 32. In some embodiment, the uploaded schedule data is processed as it is received and layover information is stored in the schedule database 32. As overlapping layovers are detected for members and their buddies, the member and buddy are notified of the overlapping layover. As with many social network systems, the social network 30 has its own social network database 34 for storing security information, member information, etc. In this embodiment, several members 12/14/16 are directly or indirectly connected to the social network 30 through the network 10. The first user is connected through the cellular network 50 and notified either by a voice message or text message sent from the social network 30, through the Internet 10 and through the cellular network 50 to a smartphone 13 used by the first member 12. The second user 14 is connected through the paging network 55 and notified by a alpha or numeric page message sent from the social network 30, through the Internet 10 and through the paging network 55 to a pager 15 used by the second member 14. The third user 16 is connected through the Internet 10 and notified by an email message sent from the social network 30 through the Internet 10 to a personal computer 17 used by the third member 16.

As with FIG. 1, this arrangement also optionally supports event codes 474 as described above.

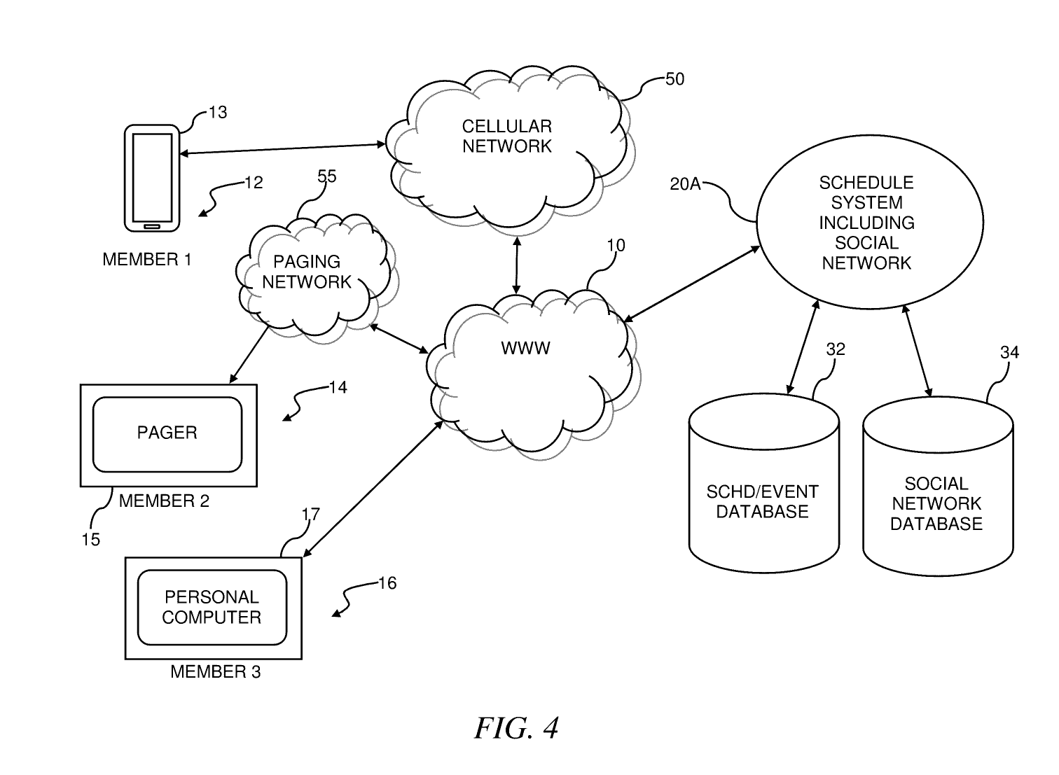

Referring to FIG. 4, another schematic view of the system for travelers with layovers is shown. In this, a combined schedule system and social network 20A is described. For example, the social network part 30 is integrated into the same server system as the scheduling system 20. A schedule system 20 is, for example, an airline personnel schedule system that assigns pilots and flight attendants to specific flight schedules. The combined schedule system and social network 20A has access to a schedule/event database 22 where the scheduling data is stored. The combined schedule system and social network 20A extracts the data from the schedule/event database 32 needed to perform layover matching. As overlapping layovers are detected for members and their buddies, the member and buddy are notified of the overlapping layover. As with many social network systems, the combined schedule system and social network 20A has its own social network database 34 for storing security information, member information, etc. In this embodiment, several members 12/14/16 are directly or indirectly connected to the combined schedule system and social network 20A through the network 10. The first user is connected through the cellular network 50 and notified either by a voice message or text message sent from the combined schedule system and social network 20A, through the internet 10 and through the cellular network 50 to a smartphone 13 used by the first member 12. The second user 14 is connected through the paging network 55 and notified by a alpha or numeric page message sent from the combined schedule system and social network 20A, through the Internet 10 and through the paging network 55 to a pager 15 used by the second member 14. The third user 16 is connected through the Internet 10 and notified by an email message sent from the combined schedule system and social network 20A through the Internet 10 to a personal computer 17 used by the third member 16.

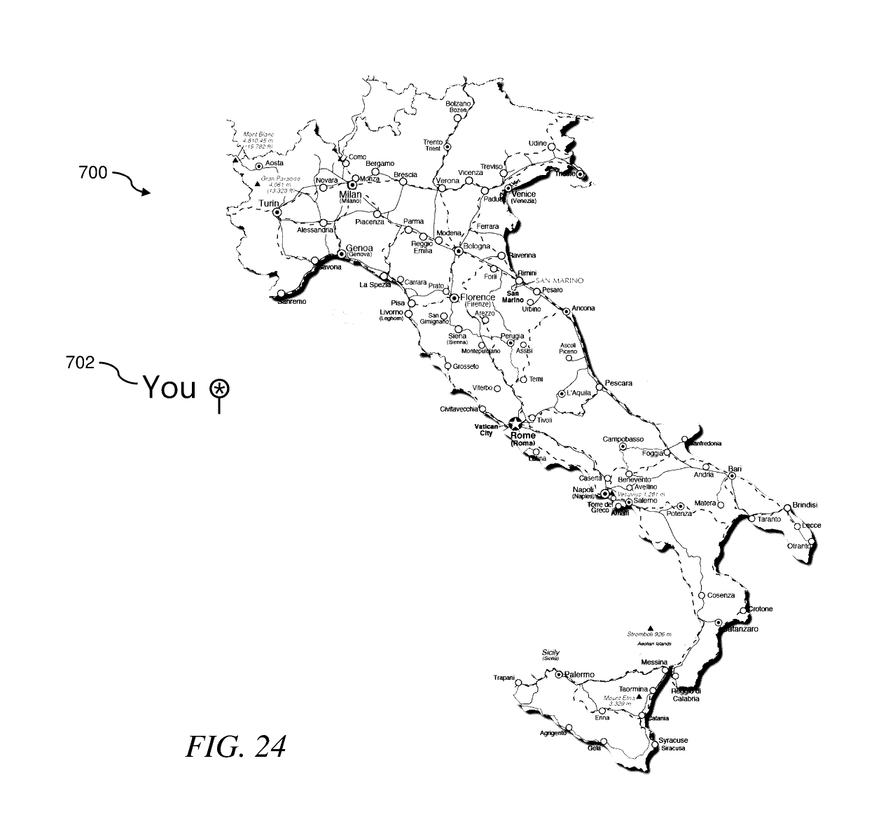

It is fully anticipated that, in some embodiments, data entry personnel enter locations, dates, times, and identifications into the system 20/20A as is anticipated where the source of layover data is, for example, a scheduling system. In such embodiments, or in other embodiments, it is also anticipated that individual users enter locations, dates, times (and implied identification through login credentials), which is stored in the schedule/event database 32 and used to determine matching layovers. Examples of a user entering layover data is described in FIGS. 24 through 26.

As with FIG. 1, this arrangement also optionally supports event codes 474 as described above.

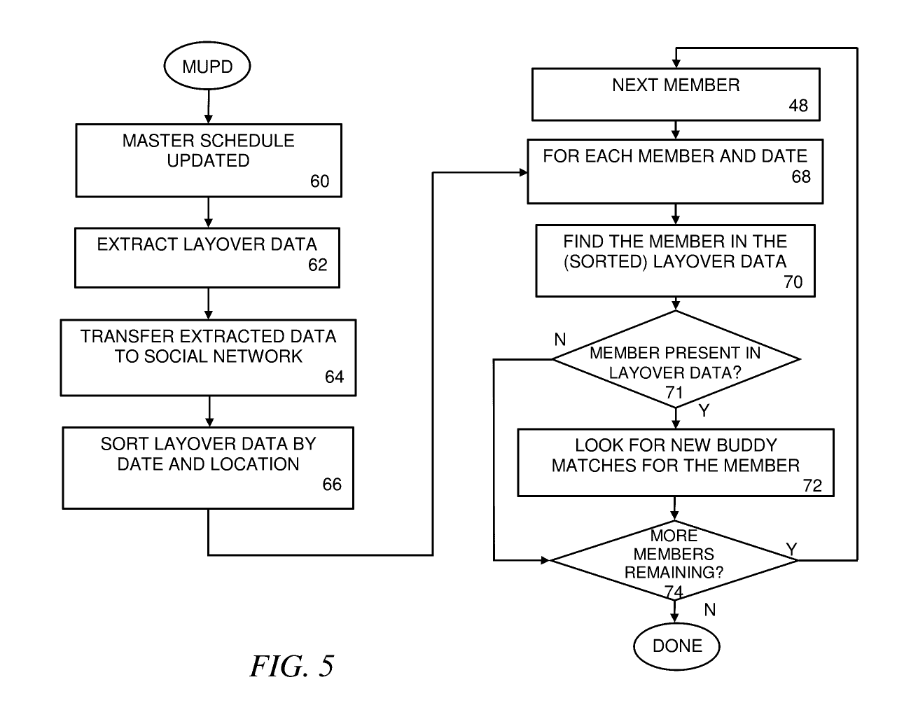

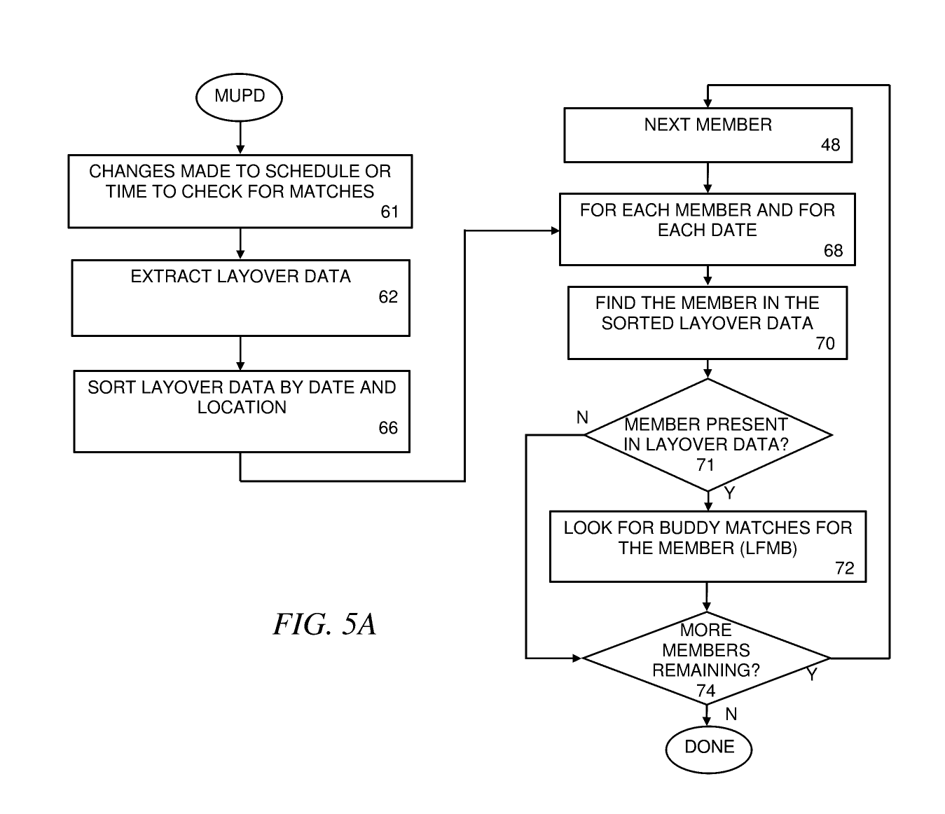

Referring to FIG. 5, an exemplary flow chart of the system for travelers with layovers is shown. In some embodiments, the system for travelers with layovers is initiated by one or more changes (e.g., a batch change) to the dataset (master schedule). In other embodiments, the dataset (master schedule) is scanned periodically, for example, at 3:00 AM (described in FIG. 5A). In this embodiment, the master schedule is updated 60 and then the layover data is extracted 62. For example, the master schedule has details regarding the aircraft type, gate number, etc., which is not needed by the social network 30 and such data is optionally stripped out when the layover data is extracted 62.

In embodiments where the schedule system 20 is distinct from the social network 30, the extracted layover data is transferred 64 from the schedule system 20 to the social network 30 either over the Internet 10 or by direct connection 21. In some embodiments, the layover data is optionally sorted 66 to improve performance. Next, for each known member (from the social network database 34) and date 68, the layover data is searched to find that member/date pair 70. For each member and date pair found in the layover data 71, the layover data is searched 72 for buddy matches for that member. This is repeated until there are no more active members 74 with the next member 48. There are many other ways known to those skilled in the art to match up such members and layovers and the present invention is not limited to any one method, including the method described.

Referring to FIG. 5A, a second exemplary flow chart of the system for travelers with layovers is shown. In this embodiment, the methods of the system for travelers with layovers are initiated by one or more changes 61 (e.g., a batch change) to the dataset (master schedule) or at a specific time 61 (e.g., 2:30 AM). The method starts by extracting layover data 62. In embodiments where the schedule system 20 is distinct from the social network 30, the extracted layover data is transferred from the schedule system 20 to the social network 30 either over the Internet 10 or by direct connection 21. In some embodiments, the layover data is sorted 66 to improve performance. Next, for each known member (from the social network database 34) and date 68, the layover data is searched to find that member/date pair 70. For each member and date pair found in the layover data 71, the layover data is searched for buddy matches for that member 72. This is repeated until there are no more active members 74 in the social network database 34 using the next member 48. There are many other ways known to those skilled in the art to match up such members and layovers and the present invention is not limited to any one method, including the method described.

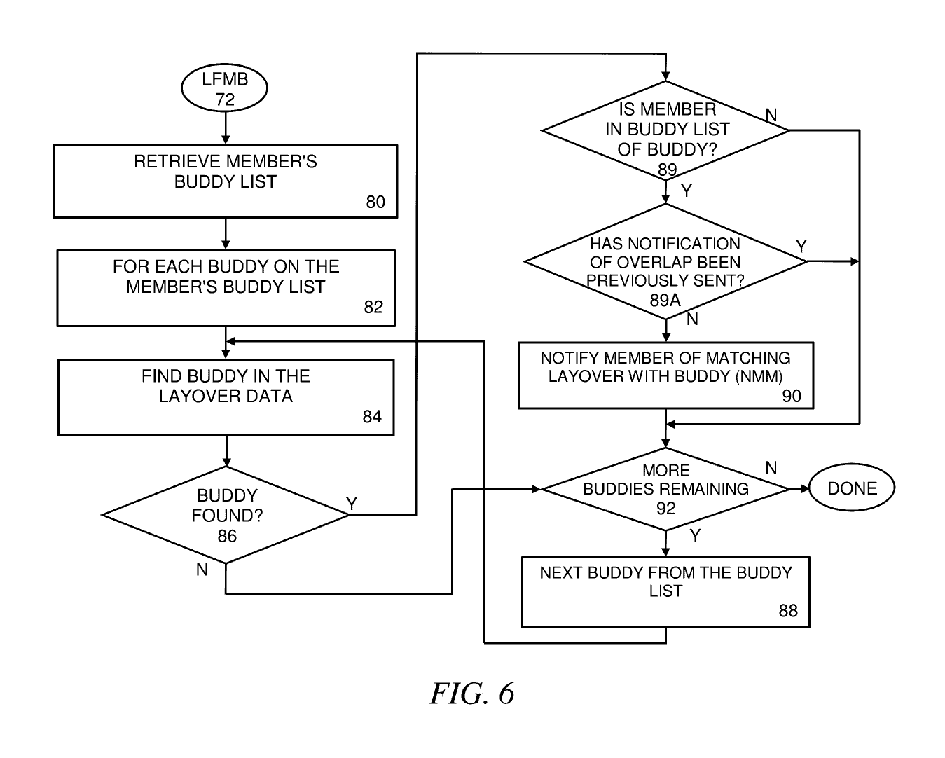

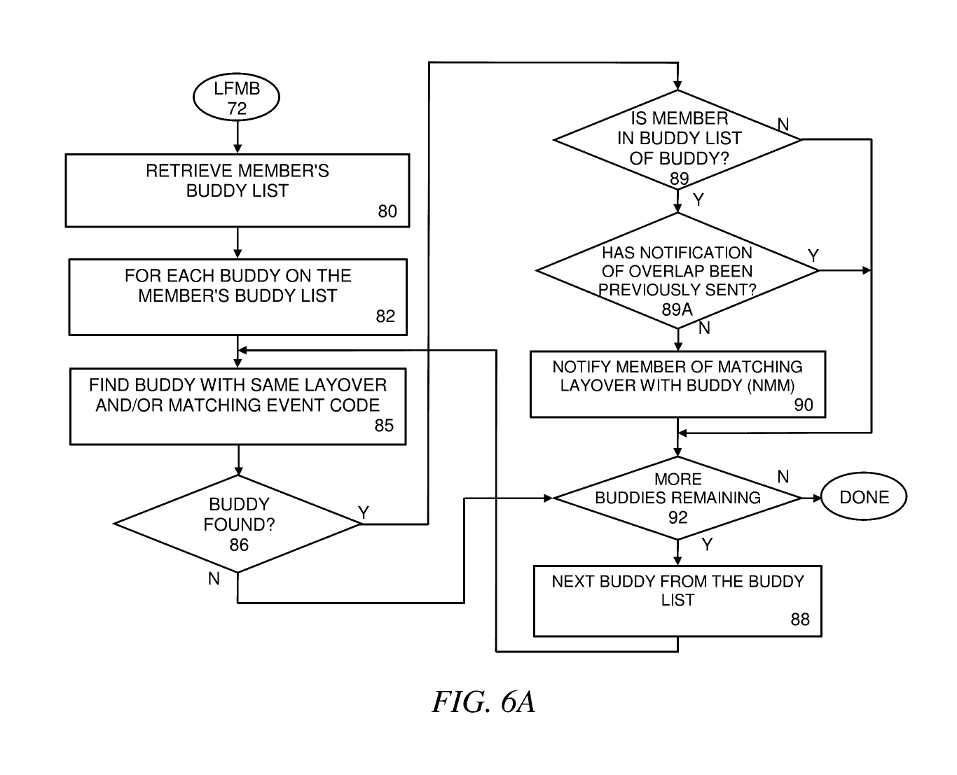

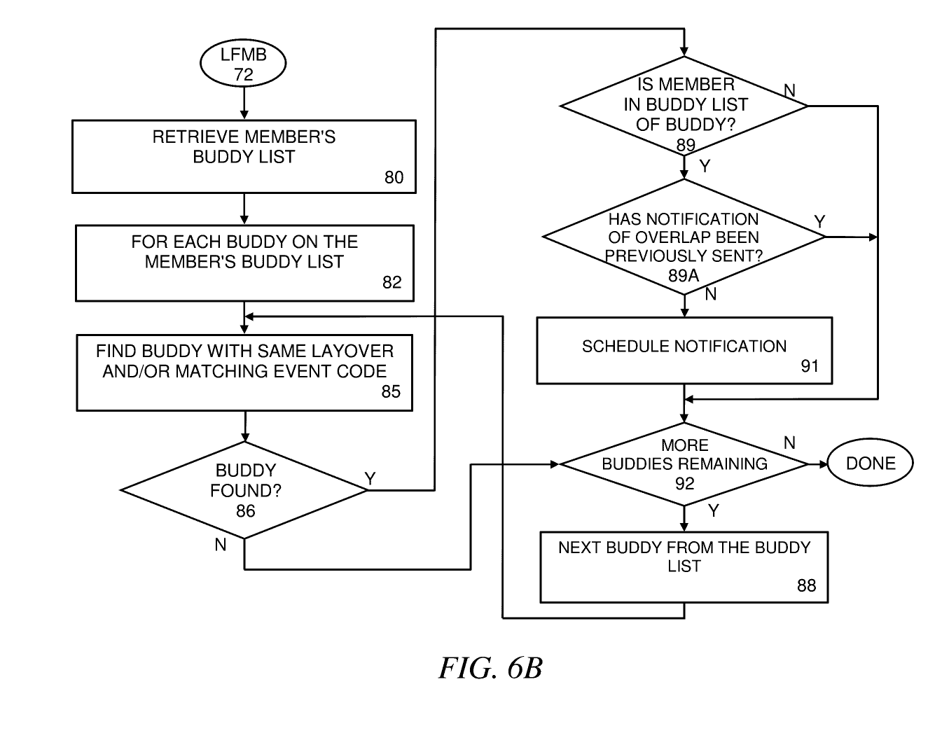

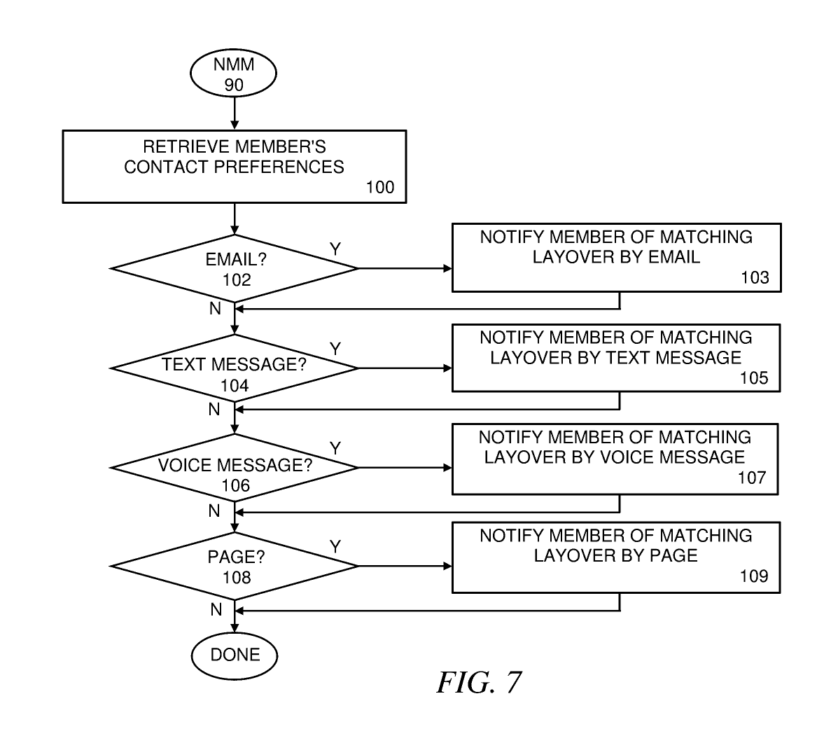

Referring to FIG. 6, a third exemplary flow chart 72 of finding matches for member's buddies in the system for travelers with layovers is shown. This part of the method operates when a member is found in the layover data (see FIGS. 5 and 5A). The member's buddy list is retrieved 80 (from the social network database 34). For each buddy on the list 82, the layover data is searched for the buddy 84. If the buddy is not found in the layover data 86 (having the same layover place and date as the member), if no more buddies exist 92, the flow is complete. Otherwise, the next buddy is retrieved 88 from the list and if there are more buddies on the list 92, the method continues. If the buddy is found in the layover data 86, a test is performed to determine if the member is a buddy (e.g., the member is on the buddy's buddy list) 89. This is one way to determine if the buddy allows the member to access the buddy's schedule data. There are other ways known to provide such permission, including but not limited to, the buddy allowing all members access, etc. If the member is allowed to access the buddy's schedule (e.g., on the buddy list of the buddy 89), optionally, a test 89A is performed to determine if this same notification has been already been made. There are many ways to determine if a notification has already been made, for example, recording each notification in a database/list and consulting that database/list to determine if a notification matches a previous notification record. If no prior notification was made 89A, the member is notified of a matching layover 90 (see FIG. 7) and if there are more buddies on the list 92, the method continues. If more buddies remain 92, the next buddy from the buddy list is accessed 88 and the method continues. If there are no more buddies on the list 92, the method is done.

Referring to FIG. 6A, a fourth exemplary flow chart 72 of finding matches for member's buddies in the system for travelers with layovers is shown. This part of the method operates when a member is found in the layover data (see FIGS. 5 and 5A). The member's buddy list is retrieved 80 (from the social network database 34). For each buddy on the list 82, the layover data is searched for the buddy 85 having the same layover and/or matching event code (e.g., both the member and buddy will be at the same location for an overlapping time period and/or will have a matching event code indicating, for example, both are attending the same event). If the buddy is not found in the layover data 86 (having the same layover place and date, and/or event code as the member), then, if no more buddies exist 92, the flow is complete. Otherwise, the next buddy is retrieved 88 from the list, and if there are more buddies on the list 92, the method continues. If the buddy is found in the layover data 86, a test is performed to determine if the member is a buddy (e.g., the member is on the buddy's buddy list) 89. This is one way to determine if the buddy allows the member to access the buddy's schedule data. There are other ways known to provide such permission, including but not limited to, the buddy allowing all members access, etc. If the member is allowed to access the buddy's schedule (e.g., on the buddy list of the buddy 89), optionally, a test 89A is performed to determine if this same notification has been already been made. There are many ways to determine if a notification has already been made, for example, recording each notification in a database/list and consulting that database/list to determine if a notification matches a previous notification record. If no prior notification was made 89A, the member and/or the buddy 89 is notified of a matching layover 90 (see FIG. 7) and if there are more buddies on the list 92, the method continues. If more buddies remain 92, the next buddy from the buddy list is accessed 88 and the method continues. If there are no more buddies on the list 92, the method is done.

Referring to FIG. 6B, a fifth exemplary flow chart 72 of finding matches for member's buddies in the system for travelers with layovers is shown. This part of the method operates when a member is found in the layover data (see FIGS. 5 and 5A). The member's buddy list is retrieved 80 (from the social network database 34). For each buddy on the list 82, the layover data is searched for the buddy 85 having the same layover or matching event code (e.g., both the member and buddy will be at the same location for an overlapping time period or both the member and the buddy have a matching event code indicating, for example, both are attending the same event). If the buddy is not found in the layover data 86 (having the same layover place and date, and/or event code as the member), then, if no more buddies exist 92, the flow is complete. Otherwise, the next buddy is retrieved 88 from the list, and if there are more buddies on the list 92, the method continues. If the buddy is found in the layover data 86, a test is performed to determine if the member is a buddy (e.g., the member is on the buddy's buddy list) 89. This is one way to determine if the buddy allows the member to access the buddy's schedule data. There are other ways known to provide such permission, including but not limited to, the buddy allowing all members access, etc. If the member is allowed to access the buddy's schedule (e.g., on the buddy list of the buddy 89), optionally, a test 89A is performed to determine if this same notification has been already been made. There are many ways to determine if a notification has already been made, for example, recording each notification in a database/list and consulting that database/list to determine if a notification matches a previous notification record. If no prior notification was made 89A, a notification is scheduled 91 based upon a predetermined notification interval. For example, a global notification interval is set to 48 hours before the overlap or event or each member has an administrable notification interval and one member is notified five days before the overlap or event and another member is notified 24 hours before the overlap or event. Once the pre-determined notification interval occurs, notification is sent as in FIG. 7. Now, if there are more buddies on the list 92, the next buddy from the buddy list is accessed 88 and the method continues. If there are no more buddies on the list 92, the method is done.

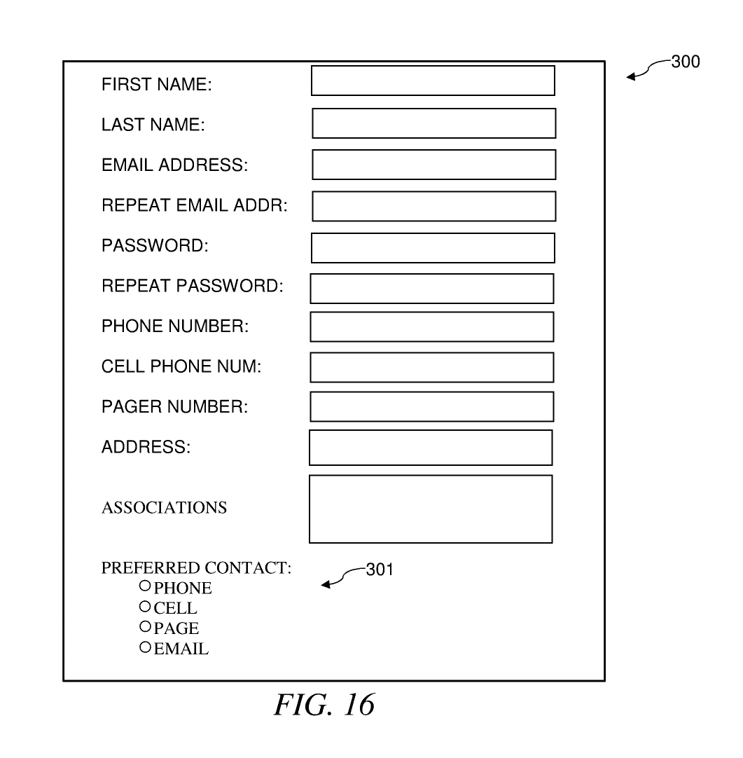

Referring to FIG. 7, a sixth exemplary flow chart 90 of a notification method of the system for travelers with layovers is shown. In this exemplary method of notifying a member of a matching layover, the member's profile is consulted 100 to determine how the member is to be notified. It is assumed that the member has previously administered their profile with specifics regarding the method of notification as for example; see the discussion of FIG. 16. In this example, the data in the member's profile indicate whether the member desires email notification 102, text message notification 104, voice message notification 106 or a page notification 108. If the member desires email notification 102, the member is notified by an email message 103 sent from the social network 20/20A, through the Internet to the member's personal computer 17. If the member desires text message notification 104, the member is notified by a text message sent 105 from the social network 20/20A, optionally through the Internet and through the cellular network 50 to the member's cell phone 13. If the member desires voice message notification 106, the member is notified by a voice message sent 107 from the social network 20/20A, optionally through the Internet and through the cellular network 50 or plain old telephone network (not shown) to the member's phone or cell phone 13. In some embodiments, the voice message is pre-recorded while in other embodiments, the text message is created using text-to-speech or other methods known in the industry. If the member desires a page notification 108, the member is notified by a page sent 109 from the social network 20/20A, optionally through the Internet and through the paging network 55 to the member's pager 15.

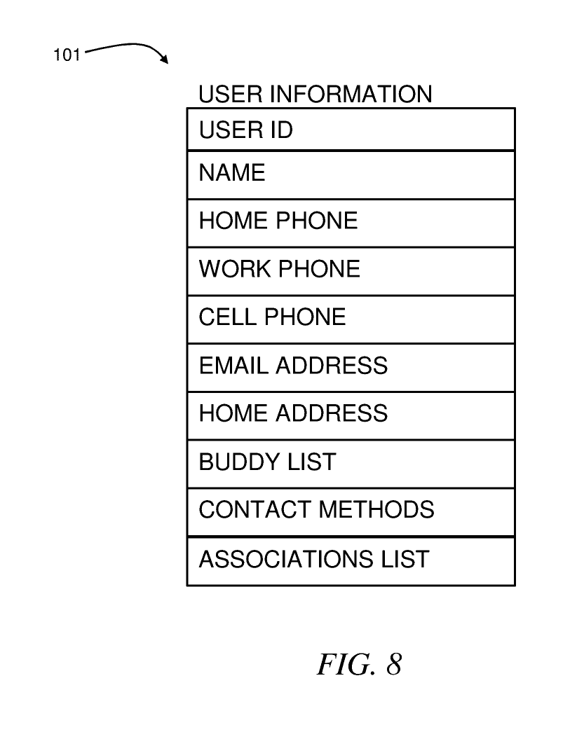

Referring to FIG. 8, a typical member data record 101 of the system for travelers with layovers is shown. Many possible data structures or databases are possible and known within the industry, all of which are included in the present invention. The member data record 101 is not limited to the fields shown. For example, in some embodiments, other fields are included such as work history so that a member will be able to search for other members who previously worked for the same company (e.g., the Air Force). The example shown in FIG. 8 includes a user id to assist in uniquely identifying the user, a member name, a home phone number, work phone number, cell phone number, email address, home address, buddy list and preferred contact methods (e.g., by text message . . . ). The buddy list is a list of other members that this member considers a “buddy” or friend, trusted in some way, etc.

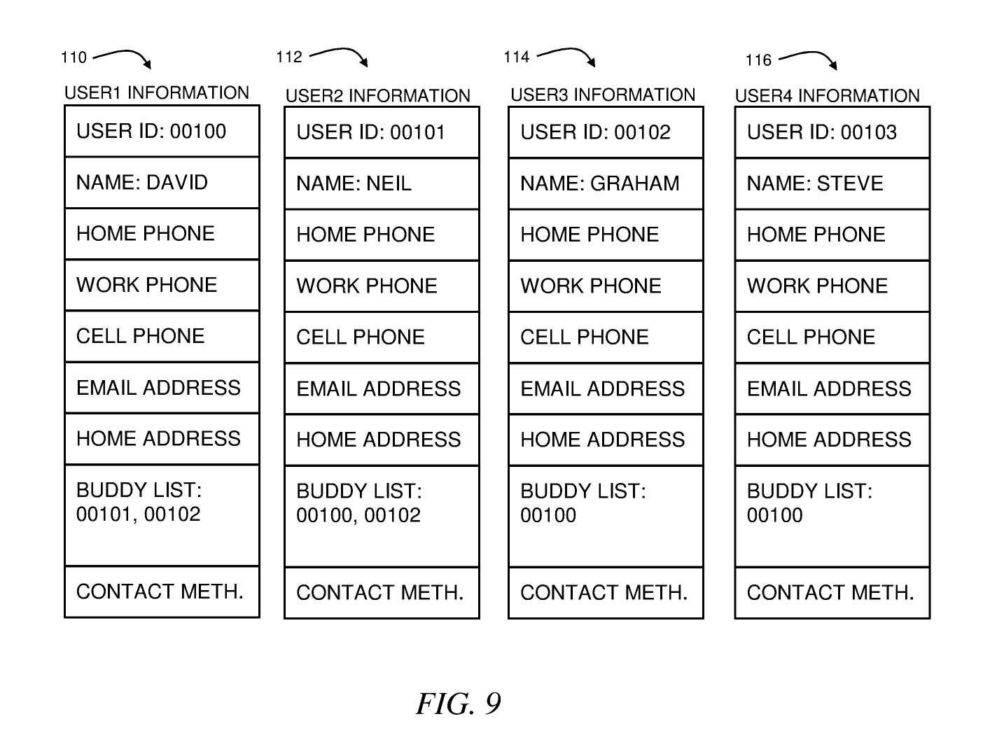

Referring to FIGS. 8 and 9, a relationship example of several member data record of the system for travelers with layovers is shown. In this very simple example, only four members are shown although in practice, hundreds or thousands of members are expected. Each member 110/112/114/116 has a user id (00100, 00101, 00102 and 00103 in this example), a name, phone numbers, email address, home address, contact method(s), a buddy list, and optionally, a list of associations. The optional associations list is a list of associations between each member and one or more schedule systems 20. For example, this list contains records or entries (unique person identifier) and each record includes an identifier of the schedule system 20 (e.g. United Airlines) and an identifier of the member (person identifier) within that schedule system 20 (e.g. badge number 123456), etc.

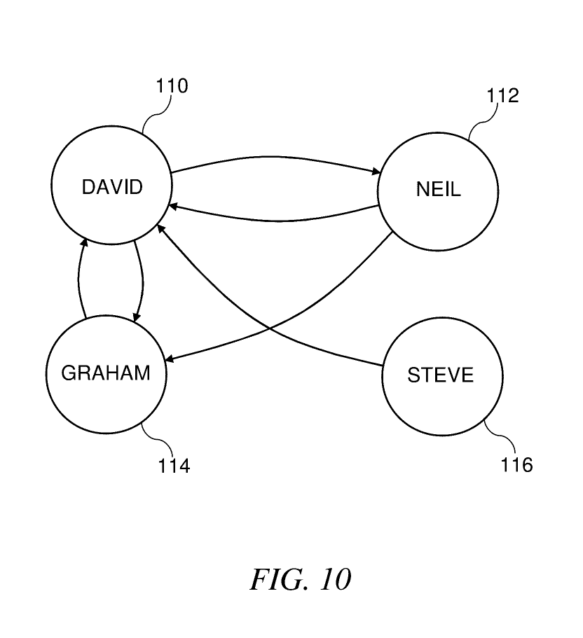

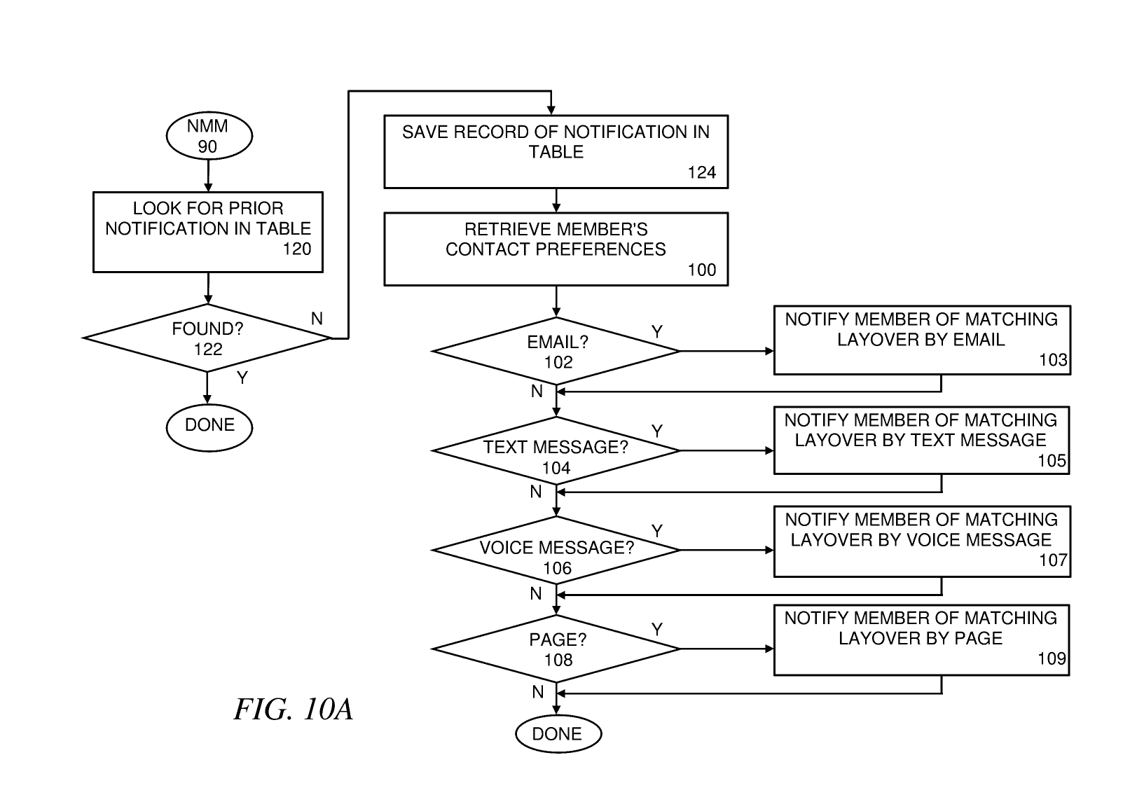

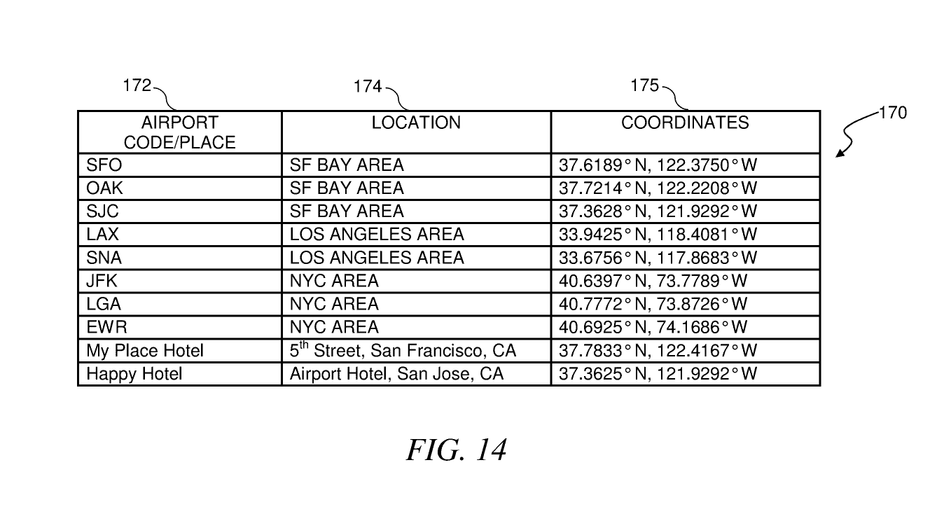

For simplicity and program operation, the buddy list consists of a list of user ids of other members who are buddies with each other. For example, David's user information includes member 00101 and member 00102 in the buddy list, so Neil and Graham are buddies of David. Likewise, Neil includes user id 00100 in his buddy list and, therefore, David is a buddy of Neil and Neil is a buddy of David. These relationships are depicted in FIG. 10. David 110 is a buddy to everyone depicted by inwardly directed arrows (his user id is included in Neil's, Graham's and Steve's buddy list). Neil is a buddy of David. Graham is a buddy of David. Neil and Steve is not a buddy to each other. As will be shown in FIGS. 13 and 14, in the preferred embodiment, notification of an overlapping layover will be sent when a two-way relationship exists such as with David and Neil or with David and Graham. In such embodiments, no notification is provided when that two-way relationship is absent such as when an overlapping layover occurs between Neil and Steve.

In some embodiments, mechanisms are provided to make sure only one notification is sent to each member for a specific layover. For example, a match for David-Graham is a duplicate of a match for Graham-David. One method to prevent duplicate notifications is to save a record of the notification in a table/database and before sending a notification, consult that table/database to see if it was previously sent. For example, when David's notification is sent, the layover match will be recorded as 00100.00102.LAX.20070901 (low member user ID first) so that when the methods find Graham's buddy list and finds David as a match, it will not send another notification because the second match will also be tagged as 00100.00102.LAX.20070901 (low member user ID first).

Referring to FIG. 10A, an exemplary method of preventing duplicate notifications is shown. A table of prior notifications is searched 120 to determine if the current notification has already been found and sent. If the current notification is found in the table 122, nothing is done since the notification was previously sent. If it is not found 122, a record of the current notification is stored in the table 124 to prevent duplicate transmissions of the same notice. Now the method continues as in FIG. 7. The member's profile is consulted 100 to determine how the member is to be notified. It is assumed that the member has previously administered their profile with specifics regarding the method of notification as for example; see the discussion of FIG. 16. In this example, the data in the member's profile indicate whether the member desires email notification 102, text message notification 104, voice message notification 106 or a page notification 108. If the member desires email notification 102, the member is notified by an email message 103 sent from the social network 20/20A, through the Internet to the member's personal computer 17. If the member desires text message notification 104, the member is notified by a text message sent 105 from the social network 20/20A, optionally through the Internet and through the cellular network 50 to the member's cell phone 13. If the member desires voice message notification 106, the member is notified by a voice message sent 107 from the social network 20/20A, optionally through the Internet and through the cellular network 50 or plain old telephone network (not shown) to the member's phone or cell phone 13. In some embodiments, the voice message is pre-recorded while in other embodiments, the text message is created using text-to-speech or other methods known in the industry. If the member desires a page notification 108, the member is notified by a page sent 109 from the social network 20/20A, optionally through the Internet and through the paging network 55 to the member's pager 15.

In some embodiments, methods are provided to allow a member to blackout certain dates or date ranges so other members are not notified of overlapping layovers. For example, if David already has plans during his layover in Atlanta on July 2^{nd}, David would create a blackout date for July 2^{nd} and the present invention would suppress sending a notification to either David or Graham regarding the July 2 layover. Alternately, the system would send a notification to David but not to Graham unless Graham also had a blackout set for July 2^{nd}.

Because it is anticipated that repetitive records are downloaded from the schedule systems 20 to the social network 30, it is anticipated that in some embodiments, mechanisms are provided so that each notification will be made once (e.g. there is memory of prior notifications or prior schedule downloads) and that if a layover changes (e.g. a flight of a member is changed or canceled) then a new notification is made informing related members of the change.

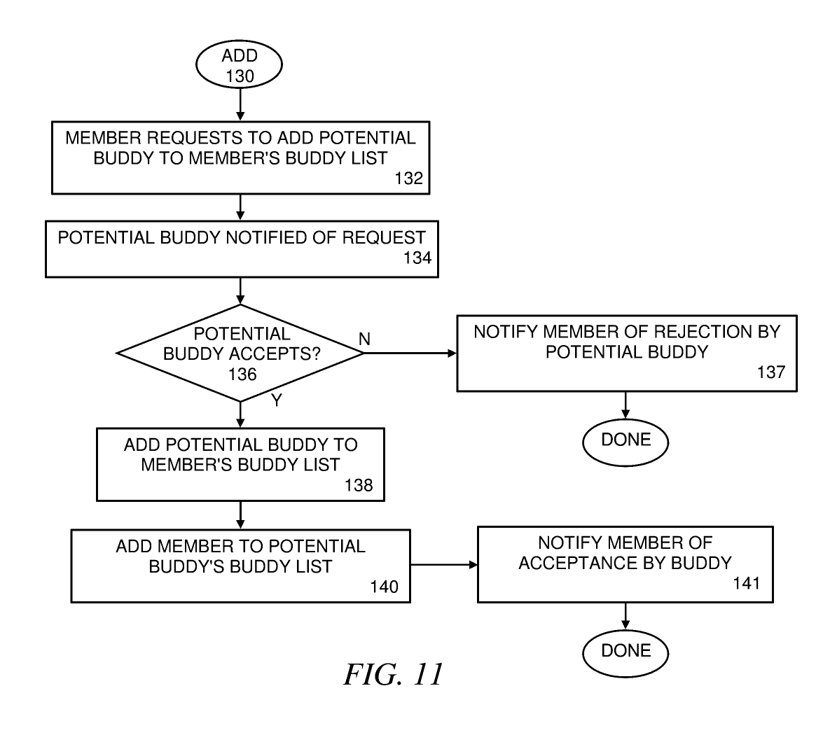

Referring to FIG. 11, a flow chart for adding a member to a buddy list in the system for travelers with layovers is shown. For example, in the example of FIGS. 9 and 10, Steve is not on any other member's buddy list.

In this exemplary method 130, the member (e.g., Steve) requests another member be added to his buddy list 132. The potential buddy (e.g., David) is notified that another member (e.g., Steve) wishes to become a member of their buddy list 134. This notification is normally sent by email, but in other embodiments, sent by page, text message, voice, etc. If the potential buddy (e.g., David) does not accept 136, the invitation remains open until the potential buddy either accepts or rejects at a later date. If the potential buddy outright rejects the request, in some embodiments, the member (e.g., Steve) is notified of the rejection 137 by email or other known methods. If the potential buddy (e.g., David) accepts, the potential buddy (e.g., David) is added to the member's (e.g., Steve) buddy list 138 and the member (e.g., Steve) is added to the potential buddy's (e.g., David) buddy list as well 140 and the member (e.g., Steve) is notified of the acceptance 141 by email or other known methods.

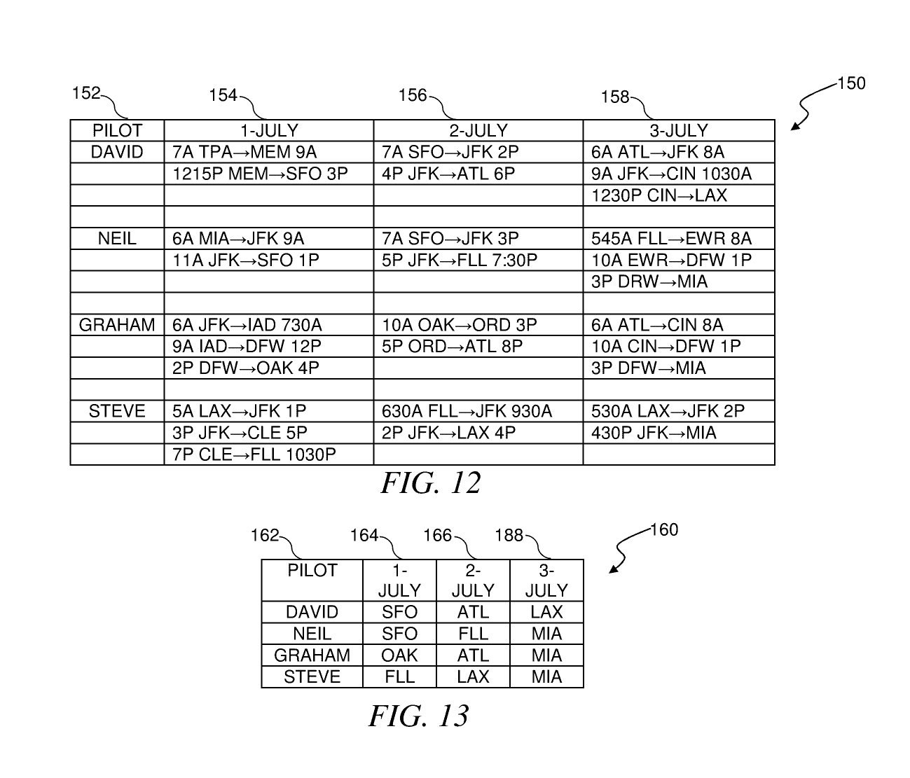

Referring to FIG. 12, a table showing an exemplary schedule 150 of the system for travelers with layovers is shown. In this simplified example, for airline personnel 152 (David, Neil, Graham and Steve) are scheduled to fly on July 1^{st}, July 2^{nd} and July 3^{rd} 154/156/158. For example, David flies from Tampa (TPA) at 7:00 AM on July 1^{st} to Memphis (MEM), arriving at 9:00 AM the same day, and then flies from Memphis (MEM) at 12:15 PM on July 1^{st} to San Francisco (SFO), arriving at 3:00 PM. Since no other flights are scheduled for David on July 1^{st}, David has a layover in San Francisco on July 1^{st}.

FIG. 13 shows a table of layovers of the exemplary schedule from FIG. 12. David and Neil have a layover in San Francisco on July 1^{st}, David and Graham in Atlanta (ATL) on July 2^{nd} and Neil, Graham and Steve have a layover in Miami (MIA) on July 3^{rd}. Prior to the present invention, it would be difficult for these people to discover that they were going to be staying overnight in the same geographic location (e.g., San Francisco Bay area) and could, perhaps, plan a social event such as dinner, etc. With the present invention, as soon as the schedule/event database 22 (or when a scan of the master schedule is performed, e.g., 3:00 AM), notifications are sent to members that have overlapping layovers with buddy members. Using the social network 20/20A database 34 examples from FIGS. 9 and 10, David and Neil would receive notification of their overlapping layover in San Francisco on July 1^{st}, David and Graham would receive notice of their overlapping layover in Atlanta on July 2^{nd} but neither Neil, Graham nor Steve would receive notification because they don't have reciprocal buddy agreements (e.g., Steve is not on Neil's buddy list, Neil is not on Graham's buddy list and Steve is not on Graham's buddy list.

Referring to FIG. 14, a table showing an exemplary location translation and mapping table 170 is shown. Scheduling systems often indicate rather precise locations such as an airport location or a hotel location. The location translation and mapping table 170 such as shown in FIG. 14 provides mechanisms to map specific locations into an area or to determine a distance between two members when they have a layover. In such, multiple fine-grained (or exact) locations/destinations 172 are mapped to more general locations 174 or coordinates 175 are provided for distance calculation. As in the example shown, three airports (SFO, OAK and SJC) map to the San Francisco Bay area since they are all within a taxi, train or bus ride to each other.

In some embodiments, the coordinates 175 of the layovers are used to calculate a distance between the layovers. For example, if a first member has a layover, staying at the My Place Hotel in San Francisco from May 1 through May 7, and a second member (buddy of the first member) has a layover, staying at the Airport Hotel in San Jose from May 5 through May 10, a distance is determined between the two coordinates 175 (e.g. latitudes and longitudes) and if that distance is within a threshold (for example, 60 miles), then notification is provided. In this case, the distance is around 50 miles, so a notification would be provided but if one of the members was in Los Angeles instead, no notice is provided since the distance is over 50 miles. In some embodiments, each member has their own distance threshold and an administrative mechanism to change their distance threshold. In such, the first member, not wishing to travel great distances, sets their distance threshold to 10 miles, while the second member, perhaps having a car rental, sets their distance threshold to 100 miles. In such scenario given the prior layover scenario, the first member will not receive notice since the Airport Hotel in San Jose is further than 10 miles from the My Place Hotel in San Francisco while the second member will receive notice.

In some embodiments, the coordinates 175 are stored within the social network for travelers with layovers while in some embodiments, some or all of the coordinates 175 are found from a map service. For example, when a location unknown to the social network for travelers with layovers is provided, the social network for travelers with layovers performs a search for that location using an address, zip code, etc., to determine the coordinate 175 of that location. For example, if the member is driving to San Francisco and staying with their parents, the address or 10-digit zip code of the member's parents is used as one coordinate 175 in the distance calculation.

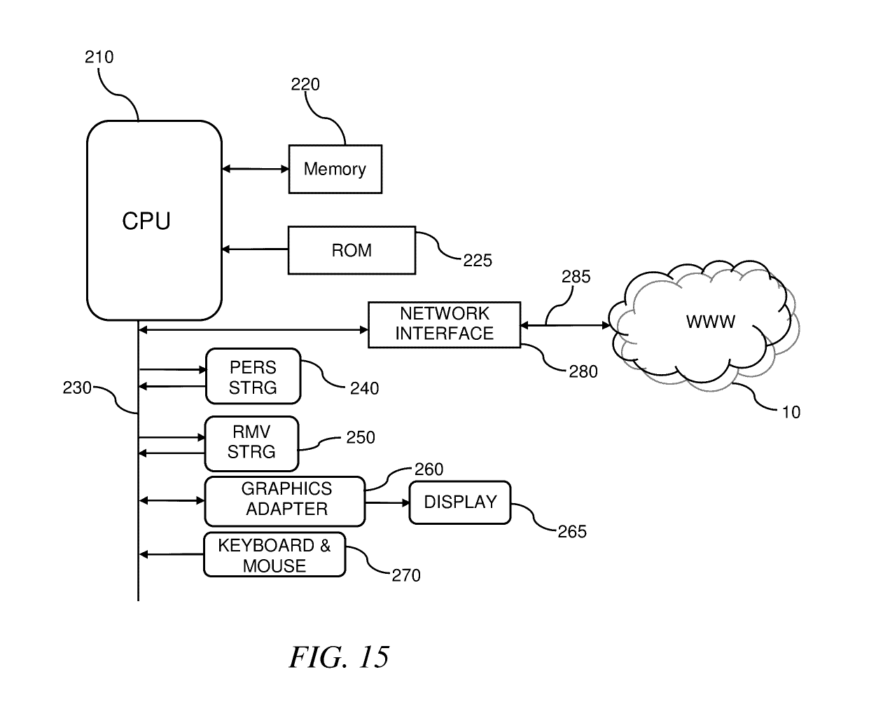

Referring to FIG. 15, a schematic diagram of a computer system of the system for travelers with layovers is shown. Although shown in its simplest form, having a single processor, many different computer architectures are known that accomplish similar results in a similar fashion and the present invention is not limited in any way to any particular computer system. The present invention works well utilizing a single processor system as shown in FIG. 15, a multiple processor system where multiple processors share resources such as memory and storage, a multiple server system where several independent servers operate in parallel (perhaps having shared access to the data or any combination). In this, a processor 210 is provided to execute stored programs that are generally stored for execution within a memory 220. The processor 210 can be any processor or a group of processors, for example an Intel Pentium-4 ® CPU or the like. The memory 220 is connected to the processor and can be any memory suitable for connection with the selected processor 210, such as SRAM, DRAM, SDRAM, RDRAM, DDR, DDR-2, etc. Firmware is stored in firmware storage 225 that is connected to the processor 210 and may include initialization software known as BIOS. This initialization software usually operates when power is applied to the system or when the system is reset. In some embodiments, the software is read and executed directly from the firmware storage 225. Alternately, the initialization software is copied into the memory 220 and executed from the memory 220 to improve performance.

Also connected to the processor 210 is a system bus 230 for connecting to peripheral subsystems such as a network interface 280, a hard disk 240, a CDROM 250, a graphics adapter 260 and a keyboard/mouse 270. The graphics adapter 260 receives commands and display information from the system bus 230 and generates a display image that is displayed on the display 265.

In general, the hard disk 240 may be used to store programs, executable code and data persistently, while the CDROM 250 may be used to load said programs, executable code and data from removable media onto the hard disk 240. These peripherals are meant to be examples of input/output devices, persistent storage and removable media storage. Other examples of persistent storage include core memory, FRAM, flash memory, etc. Other examples of removable media storage include CDRW, DVD, DVD writeable, compact flash, other removable flash media, floppy disk, ZIP®, etc. In some embodiments, other devices are connected to the system through the system bus 230 or with other input-output connections. Examples of these devices include printers; graphics tablets; joysticks; and communications adapters such as modems and Ethernet adapters.

The network interface 280 connects the computer-based system to the world-wide-web 10 through a link 285 which is, preferably, a high speed link such as a cable broadband connection, a Digital Subscriber Loop (DSL) broadband connection, a T1 line or a T3 line.

Referring to FIG. 16, a typical user interface 300 for creating a member account in the system for travelers with layovers is shown. In this typical user interface 300, the new member enters their name (first and last), email address, confirmation of email address, password, confirmation of password, phone number, cell phone number, pager number and address. The same or similar user interface is presented when the member needs to change/update any of their personal information. In social network systems 30 in which an association mechanism is provided, the member adds as many associations as needed within the associations interface (e.g. United Airlines: 123456, Expedia: tina@yahoo.com, etc.). The bottom of the user interface has four radio buttons 301 (circles that darken when selected) for the preferred method of contact (phone, cell, pager or email). The member selects one or more of these radio buttons 301, thereby a darkened circle indicates the member will receive notifications of overlapping layovers by the means associated with the darkened button. To restore the radio button 301 to its original non-selected state, it is selected again. Many user interface paradigms are known in the industry for obtaining user information and the example shown is just one possible user interface. All known user interfaces for obtaining user data and preferences are included in the present invention.

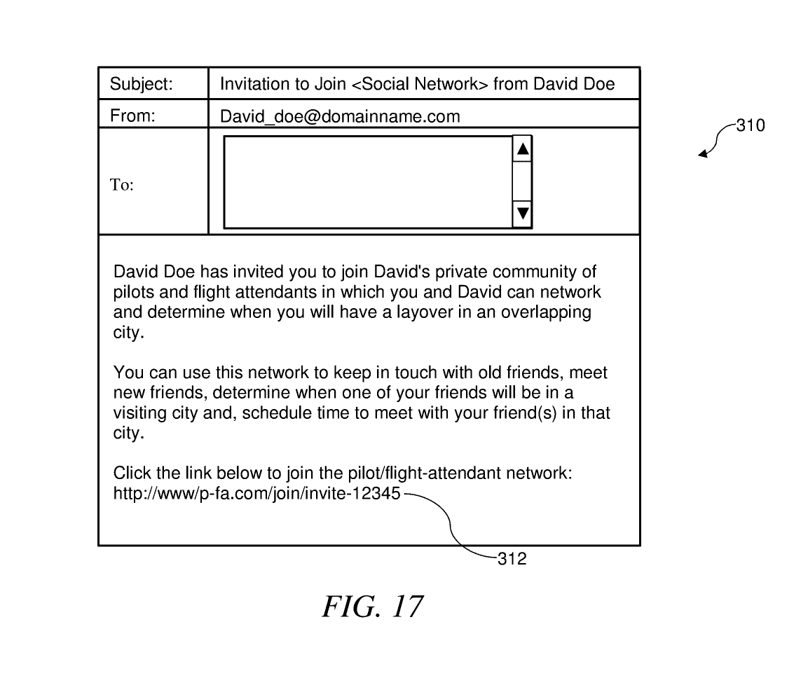

Referring to FIG. 17, a typical user interface 310 for inviting a member to be a buddy (friend) in the system for travelers with layovers is shown. In this sample email message from David, the recipient is invited to join the social network and become a member of David's buddy list. To do such, the recipient directs their browser to the cited web site 312, where they are presented with welcome user interface screens and registration user interfaces such as in FIG. 16.

FIG. 18 illustrates a relationship table 470 between an exemplary set of events 472 and event codes 474. In this, event codes 474 are assigned to various events 472 such as sporting events, expositions, shows, hotels, etc. As previously described, the event codes are, preferably, statistically unique in that, at any given time when a particular event 472 is active (e.g. for months before the event 472 and for some time after the event 472), the event code 474 uniquely corresponds to exactly one event 472. For example, during the 2014 baseball season, the event code 474 SF034555 uniquely represents exactly one event 472 being a baseball game between the San Francisco Giants and the San Diego Padres, in San Francisco on Aug. 21, 2014. It is anticipated that in 2015 or 2016, the same code is reused, though given the potential number/letter space possible, there is little need for reusing of event codes 474.

Given the table 470 and a valid event code 474, it is possible to determine the name of the event 472, the date of the event 476, the general location 478, and the venue 480. For example, given the event code 474 of SF034555, the table 470 indicates that this event is a sporting event between the San Francisco Giants and San Diego Padres, the date of the event 476 being Aug. 21, 2014, the general location being the San Francisco bay area, and the venue being AT&T Park.

For certain events 472 that occur periodically, a date code is appended to the statistically unique event code 474 to represent the date of the event 472. For example, one could stay at the M Hotel on any day of the year. Therefore, if a person was staying at the M Hotel on Aug. 21, 2014, then the event code 474 would be SF831113082114. Likewise, if a person was staying at the M Hotel on Aug. 21, 2014 for two days, then two event codes 474 are created: SF831113082114 and SF831113082214; one for each day. Alternately, a single event code SF83111308211402 is generated, where the last two characters (02) indicate the number of days. In a similar way, airlines often use the same flight number for every day that a specific flight is flown. In this example, the event 472 is Flight number D240A on a specific date. Therefore, if a person is traveling on Flight number D240A from Atlanta to Rome on Aug. 21, 2014, then the event code 474 is DL000240082114. If a person is traveling on Flight number D240A from Atlanta to Rome on Sep. 1, 2014, then the event code 474 is DL000240090114. Therefore, if a person indicates an association with the event code 474 DL000240090114, then it is known that the person is traveling from Atlanta to Rome on Sep. 1, 2014. Prior to the disclosed event codes, airline flight numbers are generally not unique within the airline industry, in that, two different airlines potentially have a flight number D240A and even less likely unique outside of the airline industry, as it is likely there is a bus schedule or a train schedule having the same number. In some embodiments, instead of a computer system generating the event code 474, a person generates the event code 474.

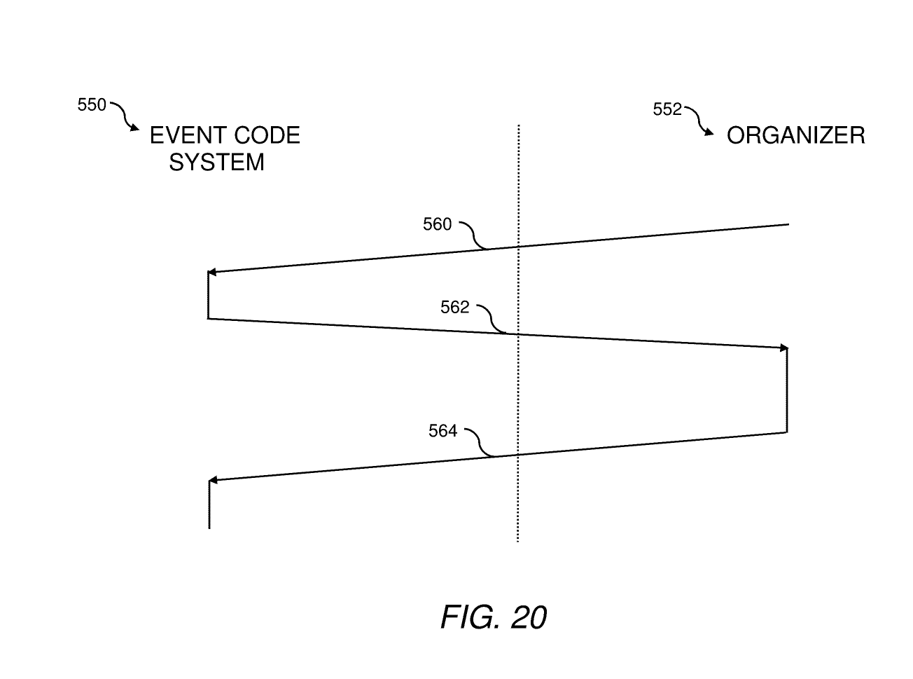

Therefore, the event code 474 provided to the user or transmitted in a data record includes a required statistically unique portion (e.g. DL000240 for Flight number D240A) provided by the event code generator 552 (see FIG. 20) and optionally a variable portion provided by the organizer 552 (e.g. airline, hotel, event organizer, theme park, etc.). In this way, mechanisms are provided for an event code to be obtained (e.g. purchased) for a recurring event such as a theme park that is open 365 days per year and the organizer (e.g., the theme park ticket system) imbeds a date into the event code 474, creating a statistically unique event code for each day of operation of the theme park. Although the examples shown in FIG. 18 disclose that the statistically unique part of the event code 474 is at the beginning of the event code 474 and the sequence portion (e.g. date as MMDDYY) is at the end of the event code 474, this is but an example, and there is no set requirement for any particular order and/or representation. For example, it is anticipated that the sequence portion be at the beginning of the event code 474 or, instead of the sequence portion being a date (as in MMDDYY), the sequence portion is, for example, a sequential number (e.g. 00100, 00101, 00102, etc.) or any set of characters that the organizer needs to include based upon a template provided by the event code generator 550. By template, the event code generator 550 specifies the number of positions and the character space that is possible in the sequence portion (or variable portion) such as, six digits, all numeric; or four alphanumeric digits, etc. By requiring the organizer 552 to follow such a template, the overall structure of the event code 474 is maintained, though there is no limitation that a template must be provided and/or followed.

By generating statistically unique event codes 474 and providing the event codes 474 to end users and/or including the event codes in data records, companies such as ticket companies, sports franchises, airlines, hotels, car rental agencies, bus companies, cruise companies, railroads, convention organizers, concert promoters, charities, etc., provide the end users with improved features and usability.

In one embodiment, the event codes 474 are reported directly to the end user's for the end user's own personal use, for inclusion in email, text messages, social network postings, etc. In such, when the end user adds the event code 474 to, for example, a form on a social network page, the social network checks all other users in that user's circle of friends (e.g. buddies) to see if anyone else has a matching event code 474 and reports any matches to that end user and/or to each buddy having the matching event code 474. For example, if the end user purchases tickets to a baseball game between the San Francisco Giants and San Diego Padres for Aug. 21, 2014 and receives the event code 474 of SF034555, the end user then enter SF034555 into a user interface of a social network and any others in that user's circle (buddies) having recorded the same event code 474 are notified and/or the user is notified. Therefore if two buddies of that end user also had entered the event code 474 of SF034555 into the social network, then all three will be planning on attending the San Francisco Giants and San Diego Padres game for Aug. 21, 2014. By each knowing that the others will be attending the same event 472, opportunities are present that were not readily available in the past, for example, getting together before/after the game, carpooling, sharing a taxi, etc. This provides an improved user experience while also providing possible benefits to the event organizers such as less parking demands, potential for the buddies to eat at the event with each other, etc. Further, if ride sharing results, there is an overall positive environmental impact.

In some embodiments, event codes 474 are provided after arranging for an event such as purchasing a ticket to a show, reserving an airline flight, signing up for a free event such as an evangelist meeting, etc.

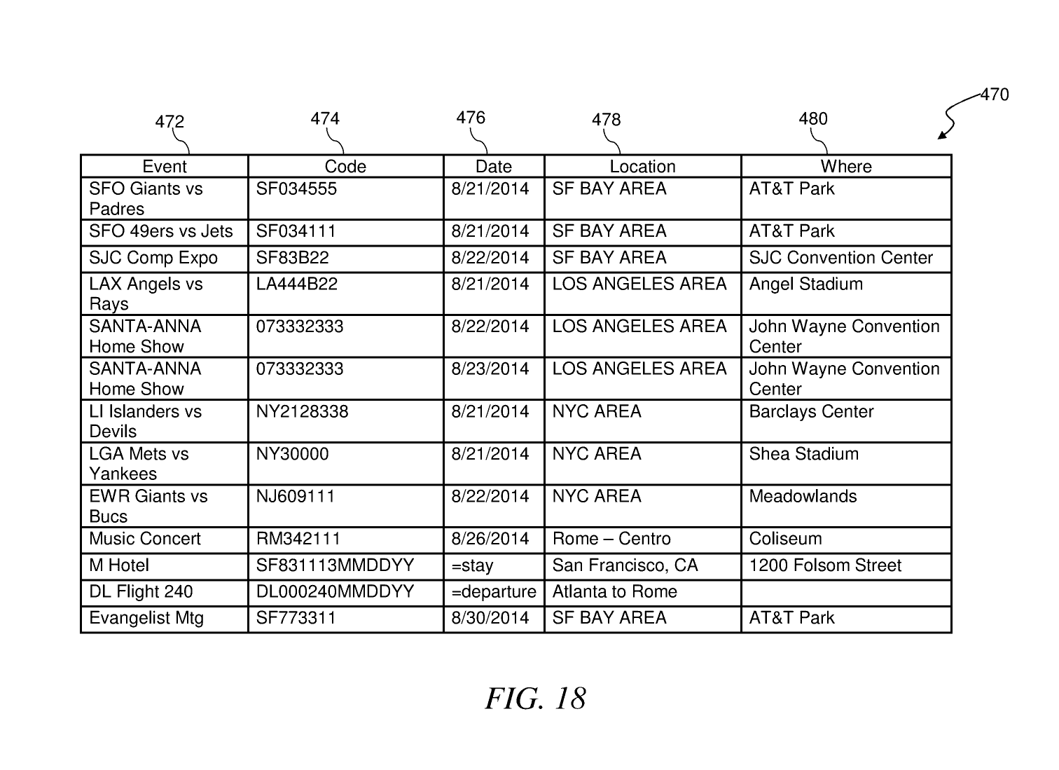

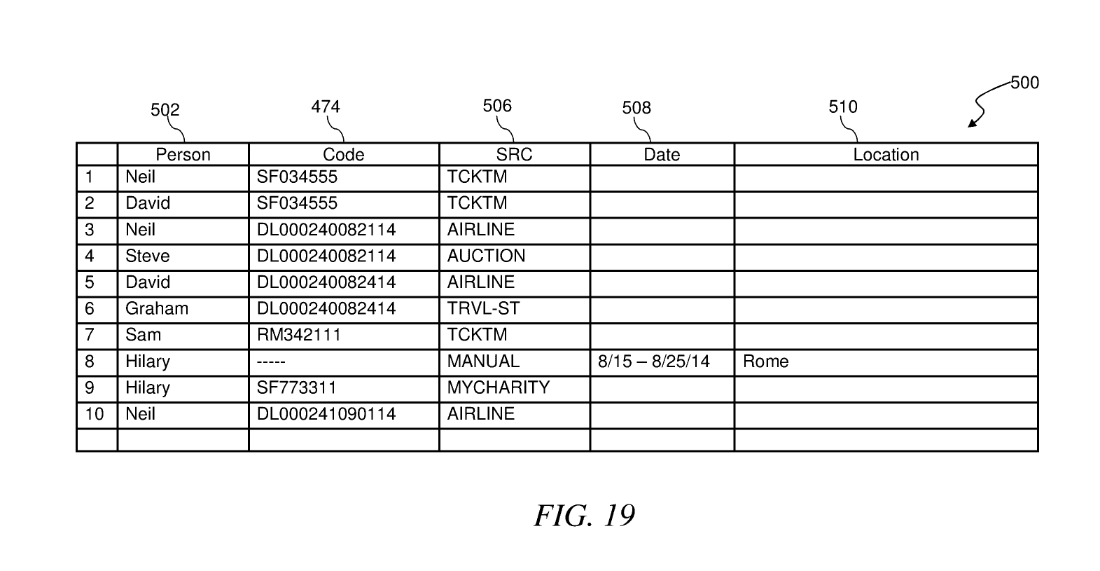

In some embodiments, as shown in FIG. 19, the event codes 474 are included in data records 500 that are, for example, transmitted to the social network from one or more sources such as ticket sales companies, airlines, travel auction sites, travel sites, sport franchises, charity events, etc. In the exemplary set of downloaded records, the first, second, and seventh records are from (SRC 506) ticket sales companies, the third, fifth, and tenth are from (SRC 506) airline web sites, the fourth is from (SRC 506) an on-line auction site, the sixth and eight are from (SRC 506) a travel web site, and the 9^{th} record is from a charity evangelist meeting. Note that the eighth record doesn't have an event code, in that, there is no event code in that the person 502, Hilary, is perhaps driving to the location 510 (Rome) on the date or dates 508 specified (8/15-8/25/14).

In such, if Neil and David are buddies with respect to the social network, then when these records are downloaded or at a time when the records are scanned, it is determined that both Neil and David are attending the event having an event code SF034555, which from table 470 is a baseball game on 8/21/2014, Giants against the Padres. In such, the social network will notify either Neil, David, or preferably both, according to rules set up by Neil and/or David. For example, the social network will send either or both a text message informing of the fact that both will be at the same game on 8/21/2014.

As used in the social network 30, it is anticipated that the event codes 474 be either matched with other event codes 474 as, for example, if two buddies share a common event code such as both Neil and David having a common event code 474 of SF034555, then the social network 30, finding that both have a common event code 474, issues notification (as previously described) to either Neil, David, or both being that Neil and David have declared each other as buddies. It is also anticipated that the event code 474 be translated into a date/time period using, for example, an event code table 470 as in FIG. 18, and the social network 30 process the date/time period as a layover as previously described. For example, in the data records 500 from FIG. 19, it is indicated that Hilary manually entered an event in which Hilary will be in Rome from 8/15/14 to 8/25/14, perhaps driving to Rome from somewhere else in Italy. There is also a record that Neil will be traveling to Rome on a flight that leaves Atlanta on 08/21/2014 (arrives in Rome on 8/22/2014). In this example, the social network 30 translates the event code DL000240082114 of Neil into a date range starting with the arrival time (not shown for clarity reasons) and ending with the next recorded date of change, in this example, the departure time from Rome of flight 241 on 09/01/2014. Therefore, from the data available, it is determined that Neil has a layover in Rome from 8/22/14 until 9/1/14. If Neil and Hilary are buddies, then this layover, overlapping with Hilary being in Rome from 8/15/14 to 8/25/14, generates a notification to Neil, Hilary, or both, depending upon preferences. Therefore, even though Hilary does not have an event code 474 associated with her visit to Rome, proper notification is performed by translating other user's event codes 474 into date ranges to determine if notification is to be made for an overlapping date range.

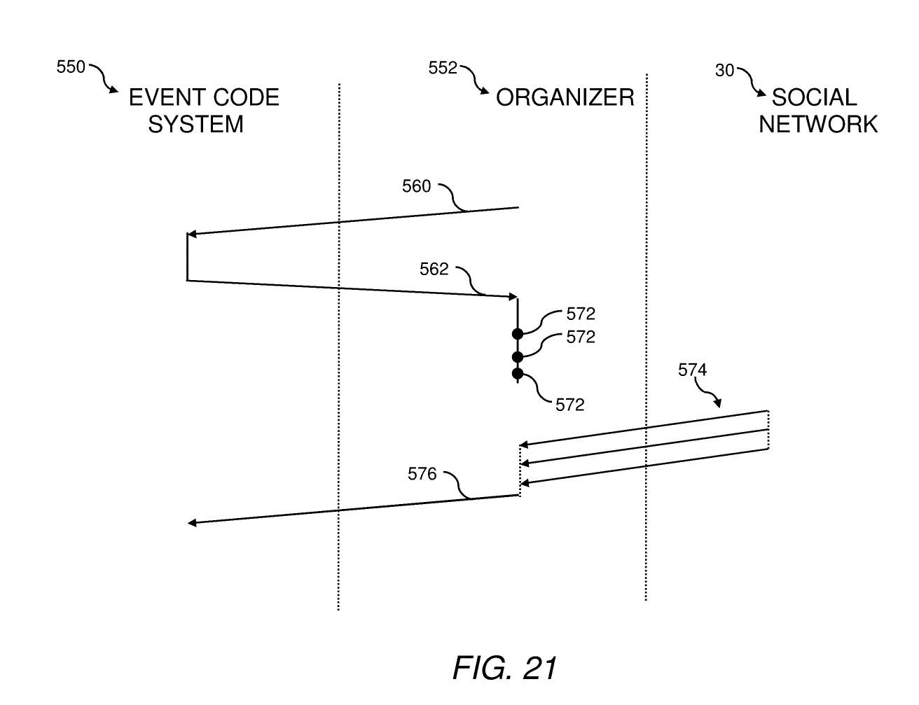

Referring to FIGS. 20 and 21, exemplary transaction sequences for obtaining and enumerating for event codes are shown. Although there are many methods of enumeration that are anticipated, two exemplary methods are described in FIGS. 20 and 21. In FIG. 20, enumeration is made on a per event code 474 basis, in that, the user of the event code 552 (typically the event organizer) pays the generator of the event code 550 (event code system) a fee for each event code 474. In this, the organizer 552 requests 560 an event code 474 from the event code system 550 and the event code system 550 responds 562 with the event code 474 and, concurrently or at a future time (e.g. after billing), the organizer 552 transfers 564 payment to the event code system 550 through any known means, including funds transfers, credit card payments, check, etc.

The second method of enumeration entails payment per use of the event code 474. For example, if an event code 474 represents a sporting event such as SF034555 represents a baseball game between the Giants and Padres on Aug. 21, 2014, then each time that event code 474 is used by, for example, a social network 30, then enumeration is made per use. In FIG. 21, enumeration is made on a per use basis. Instead of, or in addition to, paying a fee for each event code 474, the user of the event code 552 (typically the event organizer) pays the generator 550 (event code system) for each use of the event code 474. In this, the organizer 552 requests 560 an event code 474 from the event code system 550 and the event code system 550 responds 562 with the event code 474. The organizer 552 then provides 572 the event code 474 one or more times to end users, either manually or automatically. Manually is, for example, providing the event code 474 printed on a ticket, as part of a receipt, verbally, etc. Automatically is, for example, providing the event code 474 in a data record that is downloaded to, for example, the user's social network 30. Each time the event code 474 is used, a record of the use is sent from the end use system (e.g. the social network 30) to the organizer 552 and, after the event or periodically, the organizer 552 transfers 576 payment to the event code system 550 for the number of uses of the event code 474 through any known means, including funds transfers, credit card payments, check, etc.

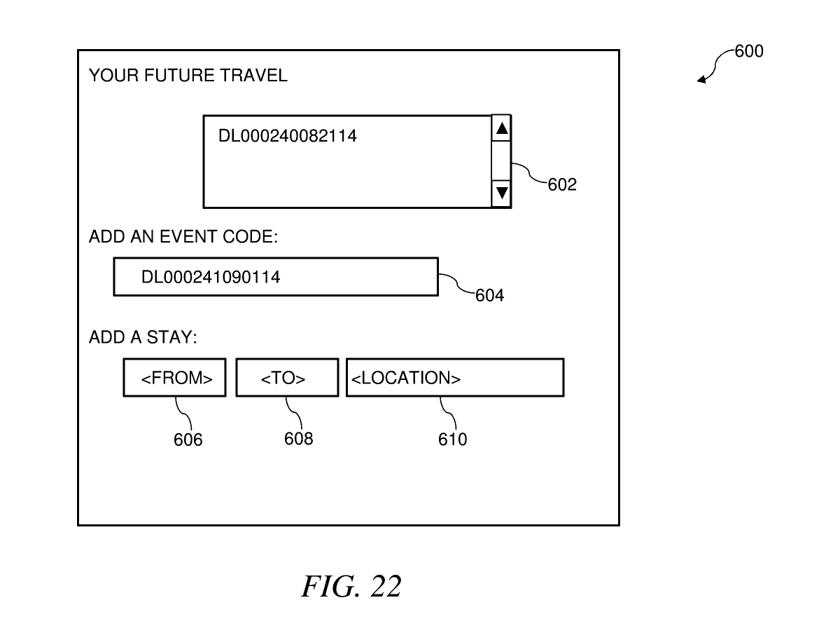

Referring to FIG. 22, an exemplary user interface 600 is shown for manual entry of event codes 474. This user interface 600 is used, for example, to manually enter an event code 474 into an event code entry box 604, for example, when a user of the social network 30 receives an event code 474 that is not automatically transmitted from the event organization 552 to the social network such as a preprinted ticket including an event code 474. Likewise, the user interface 600 (optionally) also provides for a date range to be entered into a set of stay entry boxes 606/608/610, entering for example a start date and/or time 606, an end date and/or time 608, and a location 610. Such is anticipated to be used when an event code is not available, such as when the user drives to a location.

In some such user interfaces 600, a list of future travel is summarized in a status box 602 for the user to see upcoming events, layovers, etc. It is also anticipated that the user have abilities to delete or edit entries within the status box 602.

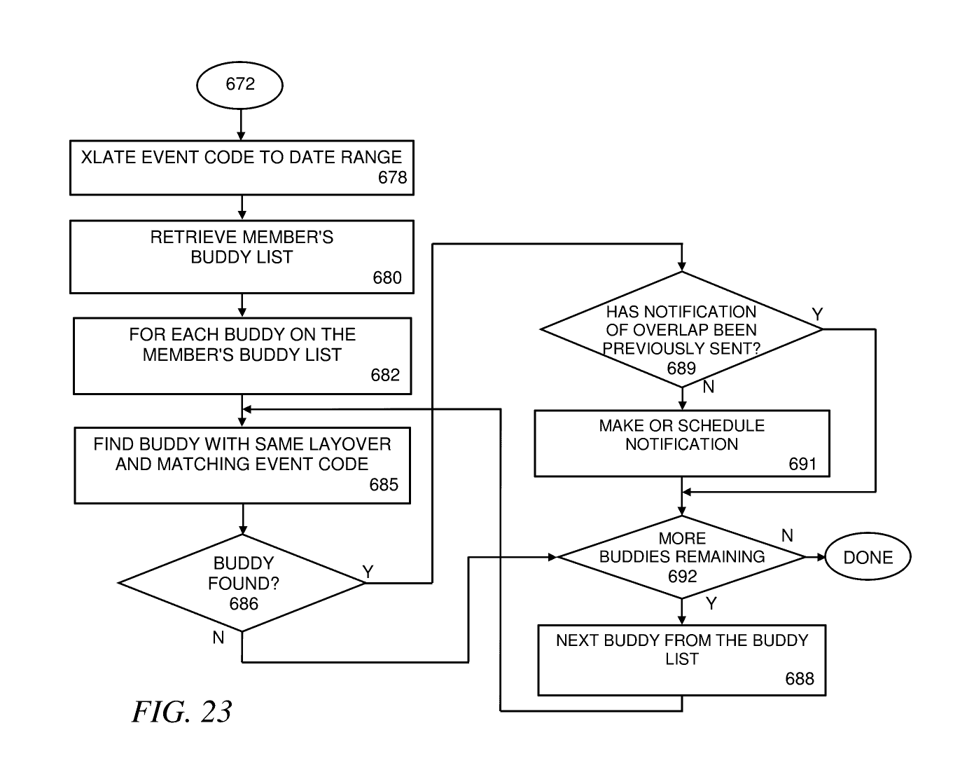

Referring to FIG. 23, an exemplary flow chart 672 of finding matches for member's buddies in the system for travelers with layovers is shown. This part of the method operates when a member either enters an event code 474 (as in FIG. 22) or an event code 474 is found in downloaded layover data (see FIGS. 5 and 5A). The event code 474 is translated 678 into a date range then the member's buddy list is retrieved 680 (from the social network database 34). For each buddy on the list 682, the layover data is searched 685 for the buddy having either the same event code 474 or having an overlapping layover (e.g., both the member and buddy will be at the same location for an overlapping time period or have a matching event code indicating, for example, both are attending the same event). If a buddy with such an overlap or matching event code 474 is not found in the layover data 686 (having the same layover place, date, or same event code 474 as the member), then, if no more buddies exist 692, the flow is complete. Otherwise, the next buddy is retrieved from the list 688, and if there are more buddies on the list 92, the method continues. If a buddy with such an overlap or matching event code 474 is found, optionally, a test 689 is performed to determine if this same notification has been already been made. There are many ways to determine if a notification has already been made, for example, recording each notification in a database/list and consulting that database/list to determine if a notification matches a previous notification record. If no prior notification was made 689, a notification is made or scheduled 691 based upon a predetermined notification interval. For example, a system-wide notification interval is set to 48 hours before the overlap or event or each member has an administrable notification interval and one member is notified five days before the overlap or event and another member is notified 24 hours before the overlap or event. Once the pre-determined notification interval occurs, notification is sent as in FIG. 7. Now, if there are more buddies on the list 692, the next buddy from the buddy list is accessed 688 and the method continues. If there are no more buddies on the list 692, the method is done.

Referring to FIGS. 24 through 26, views of an exemplary data input user interface are shown. The exemplary map of FIGS. 24 through 26 depicts an Italy map 700 as an example of a geographic area, though any geographic area is anticipated.

Likewise, the exemplary user interface of FIGS. 24 through 26 is a simplified example of one way to enter and display data regarding a trip and there are many ways to enter such data, for example, entering a place name (e.g., a city name or a landmark name such as the Eiffel Tower) or a latitude/longitude, along with a date and/or time range (e.g. “Rome from 2/15/2015 at 13:15 to 3/02/2015 at 07:30).

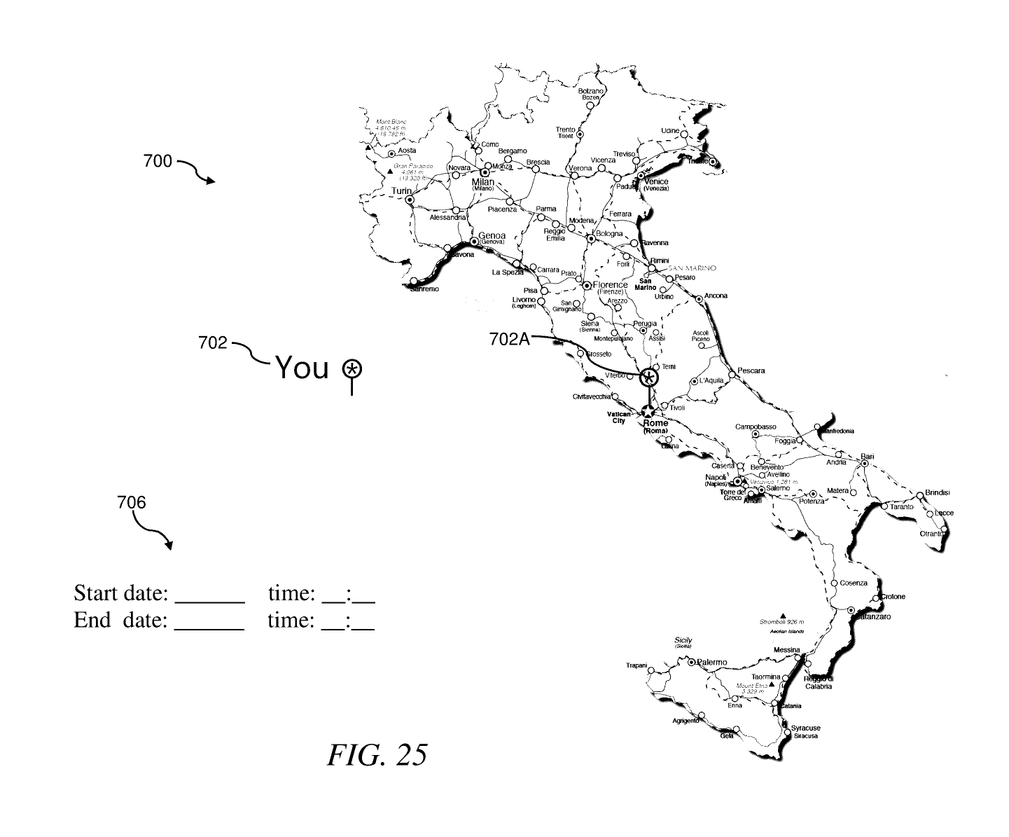

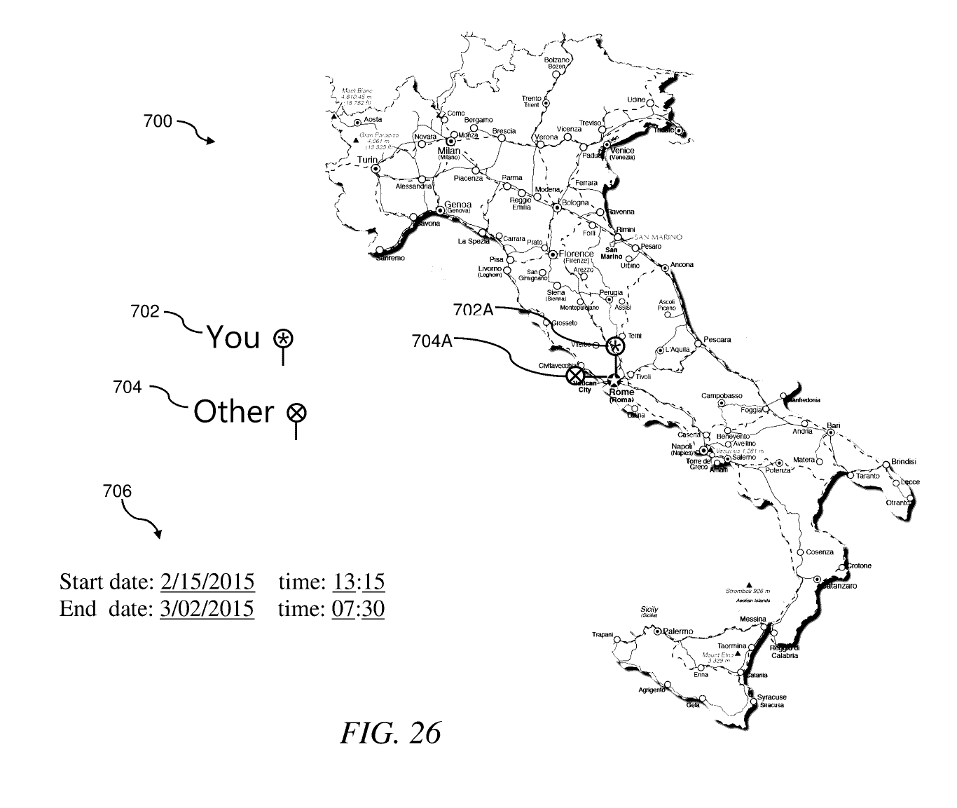

In the exemplary user interface of FIGS. 24 through 26, the user is provided with an icon representing a push-pin 702. This push-pin 702 is dragged by the user to establish a location at which the user will be located at some time in the future. In FIG. 24, no push-pins 702 have been placed on the map 700. In FIG. 25, a push-pin 702A has been dragged and dropped on the map 700 in the location at which the user will be at some time in the future (e.g., Rome in this example). Responsive to placement of a push-pin 702A on the map 700, in some embodiments, an interface 706 requests a date range, prompting the user to enter the start and end date/time for this trip to, for example, Rome. In FIG. 26, the user has entered the start and end date/time for this trip in the interface 706.

Note, that in some exemplary user interfaces, after the push-pin 702 is dragged and placed at the desired location, an additional push-pin 702 appears for placing at a different or the same location (different dates/times).

It is anticipated that, after the push-pin 702 is placed on a map 700, or any other form of user input is made such as entering a city or landmark, the location of the push-pin 702 (or city, etc.) is converted into a Cartesian system such as latitude and longitude.

Now, after the coordinates are calculated and the date range 706 is obtained from the user, the layover location and date range 706 are searched for any overlaps such as an overlap with another user (buddy) shown as a second icon of a push pin 704.

Equivalent elements can be substituted for the ones set forth above such that they perform in substantially the same manner in substantially the same way for achieving substantially the same result.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A computer system having event codes, the computer system comprising:
a server computer;
software executing on the server computer maintains a list of members and, for each member, the software maintains a list of buddies of the each member, the buddies also being in the list of members;
the software receives a layover record that includes an identification of a member, a date or date/time range and a location of a layover of the member, the identification of the member uniquely identifies the member;
the software stores the layover record in a database;
the software searches the database for other layover records with overlapping date ranges and location in which the layover record of the member overlaps in date/time and location with a second layover record, the second layover record being of a buddy of the member; and
for each of the other layover records with overlapping date ranges and location, the software sends a notification to one or both persons selected from the group consisting of the member and the buddy of the member who is named in the other layover record, wherein the notification includes only the date, the date/time range of the overlap, the identification of the member and/or an identification of the buddy of the member.

2. The computer system of claim 1, wherein the software receives the layover record including the identification of the member, the date or date/time range of the layover of the member, and the location of the layover of the member from a scheduling system.

3. The computer system of claim 1, wherein the software presents a user interface through which the member enters data that is included in the layover record including the identification of the member, the date or date/time range of the layover of the member, and the location of the layover of the member.

4. The computer system of claim 3, wherein the user interface includes a map and a push-pin and the member indicates the location of the layover by dragging and dropping the push-pin onto a specific place on the map.

5. The computer system of claim 4, wherein the user interface further includes a prompt in which the member enters a date range or date/time range of the layover.

6. The computer system of claim 1, wherein the location of the layover is normalized to a Cartesian coordinate system.

7. The computer system of claim 6, wherein the Cartesian coordinate system comprises latitude and longitude.

8. The computer system of claim 1, wherein the software determines that there is an overlapping date range when the layover record of the member overlaps in date/time with the other layover record; and there is an overlapping location when the latitude and longitude in the layover record of the member is approximately the same as the latitude and the longitude in the other layover record.

9. The computer system of claim 1, wherein the date or date/time range and the location of a layover of the member is derived from an event code.

10. The computer system of claim 9, wherein the software determines if there is an overlap if the layover record of the member and the other layover record have matching event codes.

11. A method of notifying members of a social network of upcoming overlapping layovers, the social network having a database, the method comprising:
(a) maintaining a list of members and, for each member, maintaining a list of buddies of the each member;
(b) receiving a new layover record for a first member, the new layover record comprising a person identifier, a date range, and a location;
(c) searching the database for matching layover records having an overlapping date range and location with the layover date range and location of the new layover record, and if the searching finds the matching layover record and the person identifier of the matching layover record is a buddy of the first member, automatically sending a notification to one or more members selected from the group consisting of the first member and the buddy, the notification including the date range of the matching layover record, the notification is absent of both the date range of the layover record of the first member and the date range of the layover of the buddy;
(d) storing the layover record that includes the identity of the member, the date, and the location in the database; and
(e) repeating steps (a) through (d).

12. The method of claim 11, wherein each of the layover records further comprise an event code and the step of storing further comprises storing the event code in the layover record in the database.

13. The method of claim 12, wherein the step of searching also determines if there is an overlapping layover if the event codes match.

14. The method of claim 11, wherein the step of receiving a new layover record for the first member comprises presenting a user interface through which the person identifier, the date range, and the location is collected.

15. The method of claim 14, wherein the user interface provides a push-pin icon and a map in which the push-pin icon is dragged and dropped on a position on the map, thereby determining the location.

16. Program instructions tangibly embodied in a non-transitory storage medium for notifying of upcoming overlapping layovers, wherein the at least one instruction comprises:
(a) computer readable instructions maintain a list of members and, for each member, maintain a list of buddies of the each member;
(b) computer readable instructions receive a new layover record, the new layover record comprises a member identifier, a date range, an action, and a location;
(c) if the action is a new schedule entry, computer readable instructions search a database of layover records for overlapping layovers in which the new layover record and a layover record of a buddy of the member have an overlapping date range and an overlapping location; and for each overlapping layover in the set of overlapping layovers, computer readable instructions send a notification to the member and/or the buddy of the overlapping layover;
(e) if the action is a changed schedule entry, computer readable instructions search a database of layover records for previously overlapping layovers in which the new layover record and a layover record of a buddy of the member previously had an overlapping date range and an overlapping location; and for each overlapping layover in the set of overlapping layovers, computer readable instructions send a notification to the member and/or the buddy of the overlapping layover that the overlapping layover has changed;
(f) if the action is a canceled schedule entry, computer readable instructions search a database of layover records for previously overlapping layovers in which the new layover record and a layover record of a buddy of the member previously had an overlapping date range and an overlapping location; and for each overlapping layover in the set of overlapping layovers, computer readable instructions send a notification to the member and/or the buddy of the overlapping layover that the overlapping layover has been canceled;
(g) computer readable instructions store the new layover record in the database.

17. The program instructions tangibly embodied in the non-transitory storage medium of claim 16, wherein the computer readable instructions that store the new layover record further comprises computer readable instructions for converting an event code into the date range and the location in the layover record in the database.

18. The program instructions tangibly embodied in the non-transitory storage medium of claim 17, wherein the computer readable instructions that search also determine if there is the overlapping layover if the event codes match.

19. The program instructions tangibly embodied in the non-transitory storage medium of claim 16, wherein the computer readable instructions that receive also present a user interface through which a person identifier, the date range, and the location is collected.

20. The program instructions tangibly embodied in the non-transitory storage medium of claim 19, wherein the user interface includes a push-pin icon and a map in which the push-pin icon is dragged and dropped on a position on the map, thereby determining the location.
